(19) United States
(12) Patent Application Publication
(10) Pub. No.: US 2016/0357274 A1
(43) Pub. Date: Dec. 8, 2016

(54) PEN TERMINAL AND METHOD FOR CONTROLLING THE SAME

(71) Applicant: LG Electronics Inc., Seoul (KR)

(72) Inventors: Yehan Ahn, Seoul (KR); Cheegoog Kim, Seoul (KR); Mansoo Sin, Seoul (KR); Youngsok Lee, Seoul (KR); Hoyoung Kim, Seoul (KR)

(73) Assignee: LG Electronics Inc., Seoul (KR)

(21) Appl. No.: 14/978,517

(22) Filed: Dec. 22, 2015

(30) Foreign Application Priority Data
Jun. 5, 2015 (KR) 10-2015-0080142

(51) Int. Cl. G06F 3/038; G06F 17/24; G06F 3/0346; G06F 3/0354; G06F 3/01

(52) U.S. Cl. CPC G06F 3/0383; G06F 3/03545; G06F 3/017; G06F 3/0346; G06F 17/24

(57) ABSTRACT

A motion pen including a main body; a first sensing unit configured to sense a rotational movement of the main body; a second sensing unit including at least first and second sensors spaced apart from one another, and configured to sense a linear movement of the main body; and a controller configured to calculate a corrected rotational movement by using a ratio of first information received from the first sensor and second information received from the second sensor, and generate a character based on the linear movement and the corrected rotational movement.

### CROSS-REFERENCE TO RELATED APPLICATION

Pursuant to 35 U.S.C. §119(a), this application claims the benefit of earlier filing date and right of priority to Korean Application No. 10-2015-0080142, filed on Jun. 5, 2015 the contents of which is incorporated by reference herein in its entirety.

### BACKGROUND OF THE INVENTION

1. Field of the Invention

The present disclosure relates to a pen terminal allowing for handwriting input and a method for controlling the same.

2. Background of the Invention

Terminals may be generally classified as mobile/portable terminals or stationary terminals. Mobile terminals may also be classified as handheld terminals or vehicle mounted terminals. Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players.

More recently, mobile terminals have been configured to receive broadcast and multicast signals which permit viewing of content such as videos and television programs. Efforts are ongoing to support and increase the functionality of mobile terminals. Such efforts include software and hardware improvements, as well as changes and improvements in the structural components.

Recently, an external device that can interwork with a terminal, transfer a control command to the terminal, or manipulate screen information of the terminal by applying a touch has been developed. For example, the external device may be a touch pen able to apply a touch input to a touch screen of the terminal. Meanwhile, in case of using a touch pen, a terminal requires software or hardware capable of sensing a signal and a touch of the touch pen and performing a corresponding function. However, available touch pens are different for each terminal, causing user inconvenience. Also, the related art also has a problem in that, in order to use a touch pen, an external device for recognizing the touch pan is an essential device.

### SUMMARY OF THE INVENTION

Therefore, an aspect of the detailed description is to solve the above-mentioned problems and other problems.

Also, another aspect of the present disclosure is to provide a pen unit which can be independently used, without being dependent upon terminals.

Also, another aspect of the present disclosure is to provide a pen unit providing the same handwriting sense as that of conventional writing articles.

To achieve these and other advantages and in accordance with the purpose of this specification, as embodied and broadly described herein, a motion pen includes: a main body; a first sensing unit configured to sense a rotational movement of the main body; a second sensing unit configured to include at least two sensors which are disposed to be spaced apart from one another, and sense a linear movement of the main body; and a controller configured to generate a character based on the linear movement and the rotational movement sensed by the first sensing unit and the second sensing, respectively, wherein the second sensing unit includes a first sensor and a second sensor, and the controller may correct the rotational movement by using a ratio of first information received from the first sensor and second information received from the second sensor.

To achieve these and other advantages and in accordance with the purpose of this specification, as embodied and broadly described herein, a method for controlling a motion pen includes: sensing a movement of a main body; setting a reference point such that absolute coordinates corresponding to the movement of the main body based on the movement of the main body; converting relative coordinates corresponding to the movement of the main body into absolute coordinates based on the reference point; and generating a character by using the absolute coordinates.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate embodiments and together with the description serve to explain the principles of the invention.

In the drawings:

FIG. 1A is a block diagram illustrating a mobile terminal related to the present disclosure.

FIGS. 1B and 1C are conceptual views of one example of the mobile terminal, viewed from different directions;

FIG. 2A is a block diagram illustrating a configuration of a motion pen 200 according to an embodiment of the present disclosure.

FIG. 2B is a side view illustrating the motion pen according to an embodiment of the present disclosure.

FIGS. 3A and 3B are conceptual views illustrating positions of sensors of a motion pen according to an embodiment of the present disclosure.

FIG. 4 is a flow chart illustrating a method of generating a character (or a letter) according to a movement of a motion pen according to an embodiment of the present disclosure.

FIG. 5 is a conceptual view illustrating a control method of FIG. 4.

FIGS. 6A, 6B, and 7 are conceptual views illustrating a configuration of a movement of a motion pen.

FIG. 8 is a flow chart illustrating a method for correcting a movement of a main body.

FIGS. 9A, 9B, and 9C are conceptual views illustrating a rotational movement and a linear movement.

FIGS. 10A, 10B, and 10C are conceptual views illustrating a method for generating a character by correcting a movement of the main body.

FIG. 11 is a flow chart illustrating a method for generating a character according to a movement of the main body.

FIGS. 12A and 12B are conceptual views illustrating a method for generating a character according to the flow chart of FIG. 11.

FIGS. 13A, 13B, and 13C are conceptual views illustrating a method for setting a reference point.

FIG. 14 is a flow chart illustrating a method for generating a character using a motion pen and outputting the generated character.

FIGS. 15A and 15B are conceptual views illustrating the control method of FIG. 14.

FIG. 16 is a flow chart illustrating a method for executing a function associated with character information generated through a motion pen.

FIGS. 17A, 17B, 17C, 17D, 17E, 17F, 17G, and 17H are conceptual views illustrating the control method of FIG. 16.

### DETAILED DESCRIPTION OF THE INVENTION

Description will now be given in detail according to embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another. When an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, digital signage and the like.

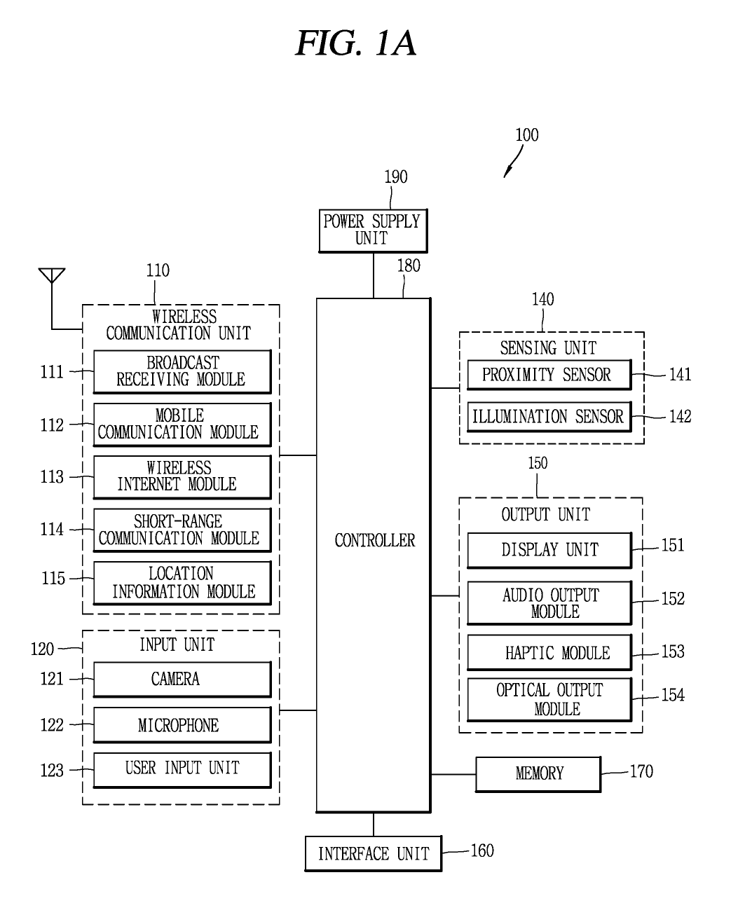

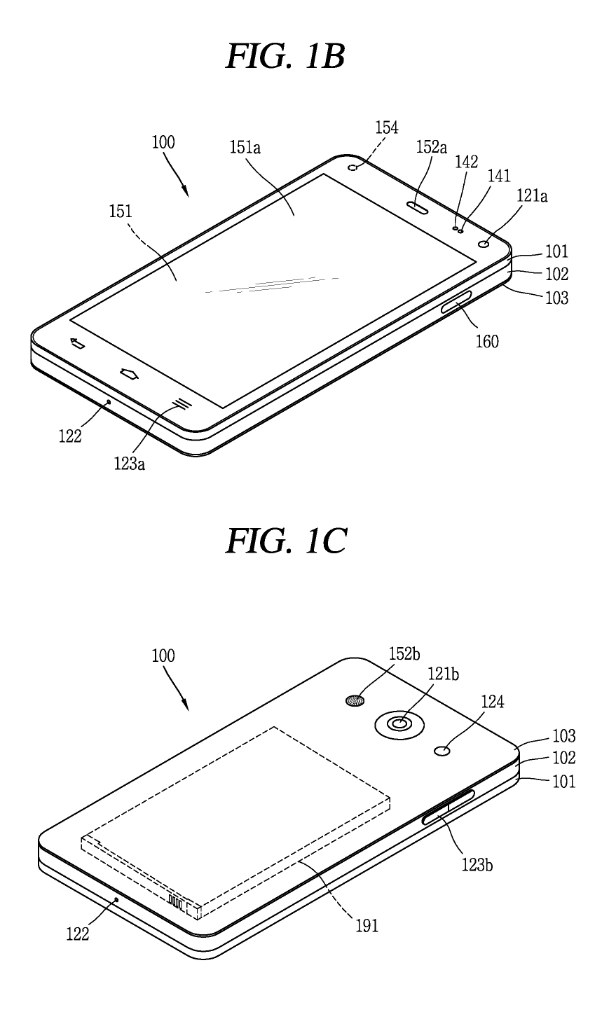

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions. The mobile terminal 100 is shown having components such as a wireless communication unit 110, an input unit 120, a sensing unit 140, an output unit 150, an interface unit 160, a memory 170, a controller 180, and a power supply unit 190. Implementing all of the illustrated components is not a requirement, and that greater or fewer components may alternatively be implemented.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by the controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 can provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the above components may operate in a cooperating manner, so as to implement an operation or a control method of a glass type terminal according to various embodiments to be explained later. The operation or the control method of the glass type terminal may be implemented on the glass type terminal by driving at least one application program stored in the memory 170.

Referring to FIGS. 1B and 1C, the mobile terminal 100 disclosed herein may be provided with a bar-type terminal body. However, the present disclosure may not be limited to this, but also may be applicable to various structures such as watch type, clip type, glasses type or folder type, flip type, slide type, swing type, swivel type, or the like, in which two and more bodies are combined with each other in a relatively movable manner.

Here, the terminal body may be understood as a conception which indicates the mobile terminal 100 as at least one assembly. The mobile terminal 100 may include a case (casing, housing, cover, etc.) forming the appearance of the terminal. In this embodiment, the case may be divided into a front case 101 and a rear case 102. Various electronic components may be incorporated into a space formed between the front case 101 and the rear case 102. At least one middle case may be additionally disposed between the front case 101 and the rear case 102

A display unit 151 may be disposed on a front surface of the terminal body to output information. As illustrated, a window 151a of the display unit 151 may be mounted to the front case 101 so as to form the front surface of the terminal body together with the front case 101. In some cases, electronic components may also be mounted to the rear case 102. Examples of those electronic components mounted to the rear case 102 may include a detachable battery, an identification module, a memory card and the like. Here, a rear cover 103 for covering the electronic components mounted may be detachably coupled to the rear case 102. Therefore, when the rear cover 103 is detached from the rear case 102, the electronic components mounted to the rear case 102 may be externally exposed.

As illustrated, when the rear cover 103 is coupled to the rear case 102, a side surface of the rear case 102 may be partially exposed. In some cases, upon the coupling, the rear case 102 may also be completely shielded by the rear cover 103. Further, the rear cover 103 may include an opening for externally exposing a camera 121b or an audio output module 152b.

The cases 101, 102, 103 may be formed by injection-molding synthetic resin or may be formed of a metal, for example, stainless steel (STS), titanium (Ti), or the like. Unlike the example which the plurality of cases form an inner space for accommodating such various components, the mobile terminal 100 may be configured such that one case forms the inner space. In this example, a mobile terminal 100 having a uni-body formed so synthetic resin or metal extends from a side surface to a rear surface may also be implemented.

Further, the mobile terminal 100 may include a waterproofing unit for preventing an introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal may include a display unit 151, first and second audio output modules 152a and 152b, a proximity sensor 141, an illumination sensor 152, an optical output module 154, first and second cameras 121a and 121b, first and second manipulation units 123a and 123b, a microphone 122, an interface unit 160 and the like.

Hereinafter, description will be given of an exemplary mobile terminal 100 that the display unit 151, the first audio output module 152a, the proximity sensor 141, the illumination sensor 142, the optical output module 154, the first camera 121a and the first manipulation unit 123a are disposed on the front surface of the terminal body, the second manipulation unit 123b, the microphone 122 and the interface unit 160 are disposed on a side surface of the terminal body, and the second audio output module 152b and the second camera 121b are disposed on a rear surface of the terminal body, with reference to FIGS. 1B and 1C.

Here, those components may not be limited to the arrangement, but be excluded or arranged on another surface if necessary. For example, the first manipulation unit 123a may not be disposed on the front surface of the terminal body, and the second audio output module 152b may be disposed on the side surface other than the rear surface of the terminal body.

The display unit 151 may output information processed in the mobile terminal 100. For example, the display unit 151 may display execution screen information of an application program driven in the mobile terminal 100 or user interface (UI) and graphic user interface (GUI) information in response to the execution screen information. The display unit 151 may include at least one of a liquid crystal display (LCD), a thin film transistor-liquid crystal display (TFT-LCD), an organic light emitting diode (OLED), a flexible display, a 3-dimensional (3D) display, and an e-ink display.

The display unit 151 may be implemented in two or more in number according to a configured aspect of the mobile terminal 100. For instance, a plurality of the display units 151 may be arranged on one surface to be spaced apart from or integrated with each other, or may be arranged on different surfaces. The display unit 151 may include a touch sensor which senses a touch onto the display unit so as to receive a control command in a touching manner. When a touch is input to the display unit 151, the touch sensor may be configured to sense this touch and the controller 180 can generate a control command corresponding to the touch. The content which is input in the touching manner may be a text or numerical value, or a menu item which can be indicated or designated in various modes.

The touch sensor may be configured in a form of film having a touch pattern. The touch sensor may be a metal wire, which is disposed between the window 151a and a display on a rear surface of the window 151a or patterned directly on the rear surface of the window 151a. Or, the touch sensor may be integrally formed with the display. For example, the touch sensor may be disposed on a substrate of the display or within the display.

The display unit 151 may form a touch screen together with the touch sensor. Here, the touch screen may serve as the user input unit 123 (see FIG. 1A). Therefore, the touch screen may replace at least some of functions of the first manipulation unit 123a. The first audio output module 152a may be implemented in the form of a receiver for transferring voice sounds to the user's ear or a loud speaker for outputting various alarm sounds or multimedia reproduction sounds.

The window 151a of the display unit 151 may include a sound hole for emitting sounds generated from the first audio output module 152a. Here, the present disclosure may not be limited to this. It may also be configured such that the sounds are released along an assembly gap between the structural bodies (for example, a gap between the window 151a and the front case 101). In this instance, a hole independently formed to output audio sounds may not be seen or hidden in terms of appearance, thereby further simplifying the appearance of the mobile terminal 100.

The optical output module 154 may output light for indicating an event generation. Examples of the event generated in the mobile terminal 100 may include a message reception, a call signal reception, a missed call, an alarm, a schedule notice, an email reception, information reception through an application, and the like. When a user's event checking is sensed, the controller may control the optical output unit 154 to stop the output of the light.

The first camera 121a may process video frames such as still or moving images obtained by the image sensor in a video call mode or a capture mode. The processed video frames may be displayed on the display unit 151 or stored in the memory 170. The first and second manipulation units 123a and 123b are examples of the user input unit 123, which may be manipulated by a user to input a command for controlling the operation of the mobile terminal 100. The first and second manipulation units 123a and 123b may also be commonly referred to as a manipulating portion, and may employ any method if it is a tactile manner allowing the user to perform manipulation with a tactile feeling such as touch, push, scroll or the like.

The drawings are illustrated on the basis that the first manipulation unit 123a is a touch key, but the present disclosure is not limited to this. For example, the first manipulation unit 123a may be configured with a mechanical key, or a combination of a touch key and a push key. The content received by the first and second manipulation units 123a and 123b may be set in various ways. For example, the first manipulation unit 123a may be used by the user to input a command such as menu, home key, cancel, search, or the like, and the second manipulation unit 123b may be used by the user to input a command, such as controlling a volume level being output from the first or second audio output module 152a or 152b, switching into a touch recognition mode of the display unit 151, or the like.

Further, as another example of the user input unit 123, a rear input unit may be disposed on the rear surface of the terminal body. The rear input unit may be manipulated by a user to input a command for controlling an operation of the mobile terminal 100. The content input may be set in various ways. For example, the rear input unit may be used by the user to input a command, such as power on/off, start, end, scroll or the like, controlling a volume level being output from the first or second audio output module 152a or 152b, switching into a touch recognition mode of the display unit 151, or the like. The rear input unit may be implemented into a form allowing a touch input, a push input or a combination thereof.

The rear input unit may be disposed to overlap the display unit 151 of the front surface in a thickness direction of the terminal body. As one example, the rear input unit may be disposed on an upper end portion of the rear surface of the terminal body such that a user can easily manipulate it using a forefinger when the user grabs the terminal body with one hand. However, the present disclosure may not be limited to this, and the position of the rear input unit may be changeable.

When the rear input unit is disposed on the rear surface of the terminal body, a new user interface may be implemented using the rear input unit. Also, the aforementioned touch screen or the rear input unit may substitute for at least part of functions of the first manipulation unit 123a located on the front surface of the terminal body. Accordingly, when the first manipulation unit 123a is not disposed on the front surface of the terminal body, the display unit 151 may be implemented to have a larger screen.

Further, the mobile terminal 100 may include a finger scan sensor which scans a user's fingerprint. The controller may use fingerprint information sensed by the finger scan sensor as an authentication means. The finger scan sensor may be installed in the display unit 151 or the user input unit 123. The microphone 122 may be formed to receive the user's voice, other sounds, and the like. The microphone 122 may be provided at a plurality of places, and configured to receive stereo sounds.

The interface unit 160 may serve as a path allowing the mobile terminal 100 to exchange data with external devices. For example, the interface unit 160 may be at least one of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b may be further mounted to the rear surface of the terminal body. The second camera 121b may have an image capturing direction, which is substantially opposite to the direction of the first camera unit 121a. The second camera 121b may include a plurality of lenses arranged along at least one line. The plurality of lenses may also be arranged in a matrix configuration. The cameras may be referred to as an ‘array camera.’ When the second camera 121b is implemented as the array camera, images may be captured in various manners using the plurality of lenses and images with better qualities may be obtained.

A flash 124 may be disposed adjacent to the second camera 121b. When an image of a subject is captured with the camera 121b, the flash 124 may illuminate the subject. The second audio output module 152b may further be disposed on the terminal body. The second audio output module 152b may implement stereophonic sound functions in conjunction with the first audio output module 152a (refer to FIG. 1A), and may be also used for implementing a speaker phone mode for call communication.

At least one antenna for wireless communication may be disposed on the terminal body. The antenna may be installed in the terminal body or formed on the case. For example, an antenna which configures a part of the broadcast receiving module 111 (see FIG. 1A) may be retractable into the terminal body. Alternatively, an antenna may be formed in a form of film to be attached onto an inner surface of the rear cover 103 or a case including a conductive material may serve as an antenna.

A power supply unit 190 for supplying power to the mobile terminal 100 may be disposed on the terminal body. The power supply unit 190 may include a batter 191 which is mounted in the terminal body or detachably coupled to an outside of the terminal body. The battery 191 may receive power via a power source cable connected to the interface unit 160. Also, the battery 191 may be (re)chargeable in a wireless manner using a wireless charger. The wireless charging may be implemented by magnetic induction or electromagnetic resonance.

Further, the drawing illustrates that the rear cover 103 is coupled to the rear case 102 for shielding the battery 191, so as to prevent separation of the battery 191 and protect the battery 191 from an external impact or foreign materials. When the battery 191 is detachable from the terminal body, the rear case 103 may be detachably coupled to the rear case 102.

An accessory for protecting an appearance or assisting or extending the functions of the mobile terminal 100 may further be provided on the mobile terminal 100. As one example of the accessory, a cover or pouch for covering or accommodating at least one surface of the mobile terminal 100 may be provided. The cover or pouch may cooperate with the display unit 151 to extend the function of the mobile terminal 100. Another example of the accessory may be a touch pen for assisting or extending a touch input onto a touch screen. Meanwhile, the present disclosure may display information processed in the mobile terminal using a flexible display. Hereinafter, description thereof will be given in detail with reference to the accompanying drawings.

Hereinafter, embodiments related to a control method that may be realized in the mobile terminal (for example, a motion pen) configured described above will be described with reference to the accompanying drawings. The same reference numerals will be used throughout to designate the same or like elements. It will be obvious by a person skilled in the art that the present invention may be embodied to any other forms without departing from the sprit and scope of the present invention. Also, in the following descriptions, drawings will be described in order of clockwise direction, starting from the drawing in an upper portion on the left.

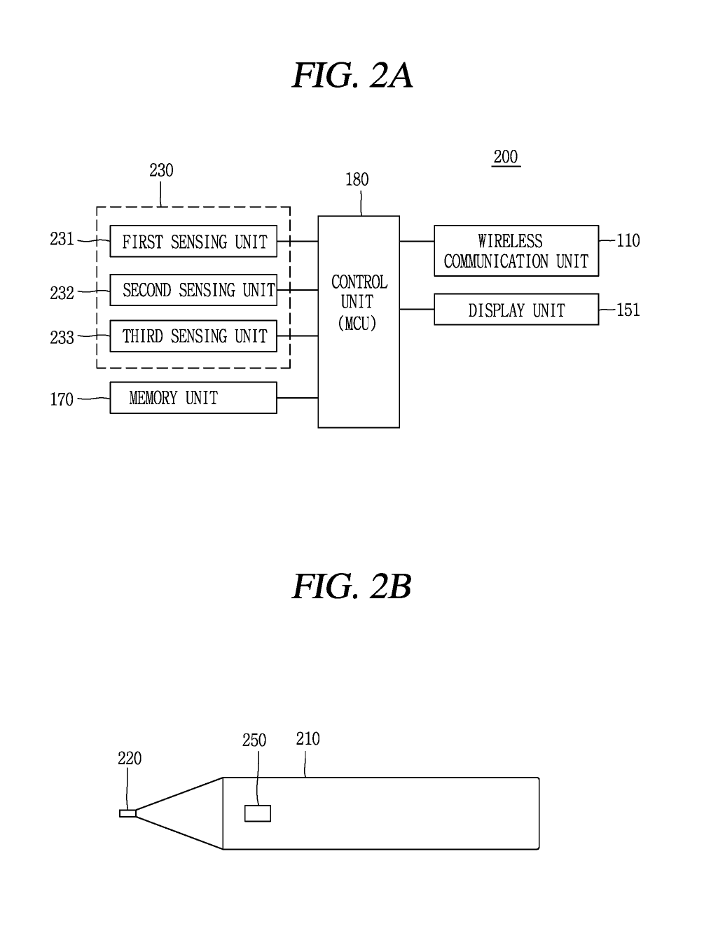

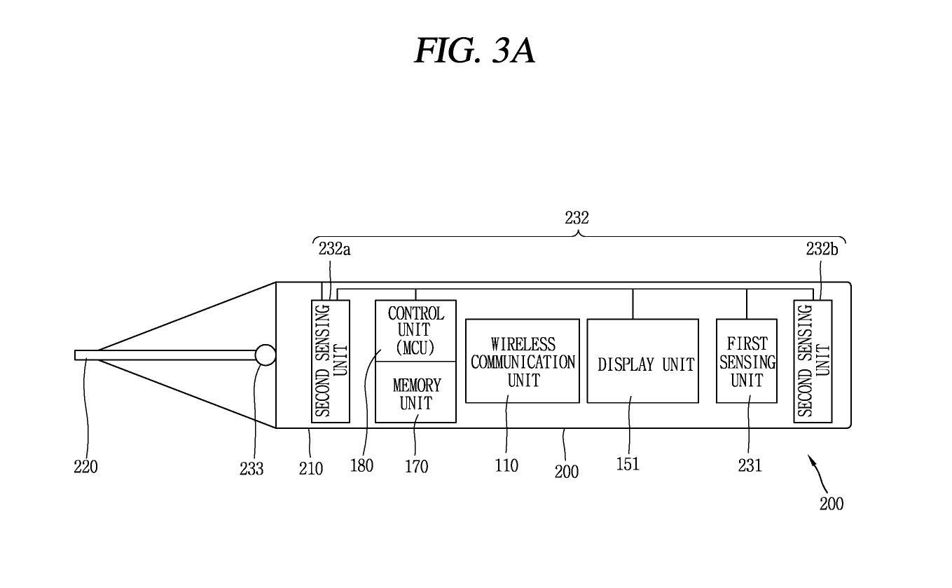

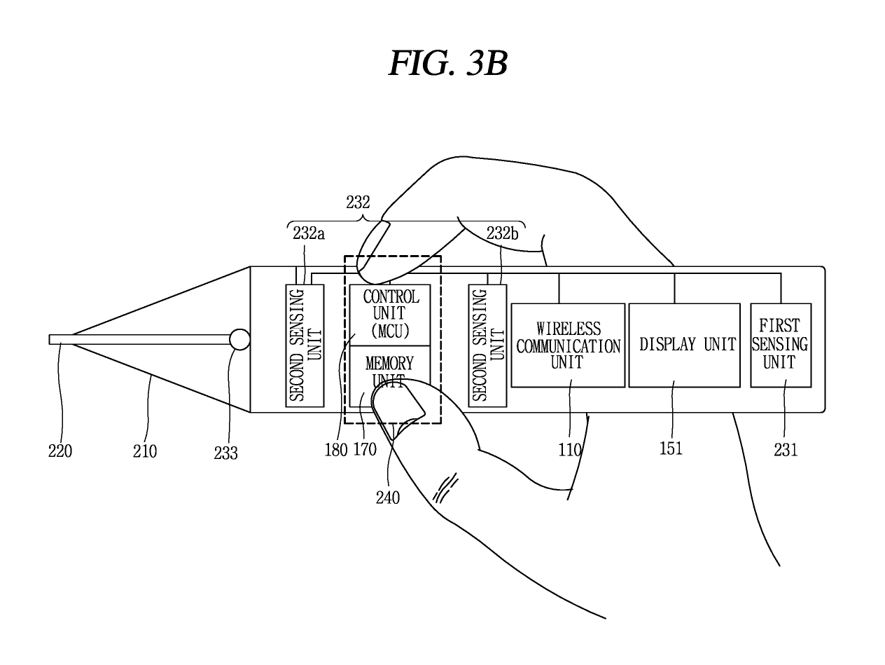

FIG. 2A is a block diagram illustrating a configuration of a motion pen 200 according to an embodiment of the present disclosure, FIG. 2B is a side view illustrating the motion pen 200 according to an embodiment of the present disclosure, and FIGS. 3A and 3B are conceptual views illustrating positions of sensors of a motion pen according to an embodiment of the present disclosure.

Referring to FIG. 2A, a motion pen 200 according to an embodiment of the present disclosure includes an operation sensing unit 230, a memory unit 170, a wireless communication unit 110, a display unit 151, and a controller 180. Also, in addition to the components of the motion pen 200, a component may be added to the motion pen 200 or any of the foregoing components of the motion pen 200 may be deleted, as necessary.

The operation sensing unit 230 recognizes an operation through a first sensing unit 231, a second sensing unit 232, and a third sensing unit 233. The operation may refer to a movement of an object or a position of an object. The first sensing unit 231 can sense a rotational movement of the motion pen 200. The rotational movement refers to a movement (or rotation) while forming an angle with respect to a preset axis.

The first sensing unit 231 may include a rotation sensor sensing a rotation of the motion pen 200. The rotation sensor can sense a rotational movement according to a scheme such as a power generation scheme, an electronic scheme, an oscillation scheme, a photoelectric scheme, a hall effect scheme, or a magnetic reluctance scheme. The first sensing unit 231 can also sense a rotational movement with respect to a plurality of reference axes. For example, the first sensing unit 231 can sense a rotational movement with respect to three axes (x axis, y axis, and z axis). The rotational sensor may be, for example, a three-axis gyro sensor.

Further, the second sensing unit 232 can sense a linear movement of the motion pen 200. The linear movement may refer to a movement from one point to another point in parallel. The second sensing unit 240 may include an accelerometer for sensing a movement of the motion pen 200 made in parallel. The accelerometer can sense an increment/decrement ratio of a speed with respect to a linear movement. Also, the accelerometer can sense a linear movement with respect to one or more axes. For example, the accelerometer can sense a linear movement with respect to each of the three axes (x axis, y axis, and z axis).

The third sensing unit 233 can sense pressure applied to the motion pen 200. In more detail, the third sensing unit 233 can sense pressure applied to a specific region (for example, a tip portion 220) of the motion pen 200. The third sensing unit 233 can sense pressure using a piezoelectric element, a change in temperature, a current, and a voltage.

The third sensing unit 233 can be disposed at one end of the tip portion 220 included in the motion pen 200. Here, the other end of the tip portion 220 may be a handwriting input terminal. That is, the third sensing unit 233 may be disposed in a direction opposite to the handwriting input terminal of the tip portion 220 and sense pressure without interfering with handwriting.

Further, the wireless communication unit 100 can perform remote communication or near-field communication. The wireless communication unit 100 can also perform communication between the motion pen 200 and a terminal, between the motion pen and a sever, and between motion pens.

The display unit 151 can display (or output) information that may be displayed electronically, such as information processed by the controller 180 and a graphic object, or the like. For example, a character (or a letter) corresponding to a movement of the motion pen 200 may be displayed on the display unit 151.

The memory unit 170 can store various types of information related to an operation of the motion pen 200. For example, the memory unit 170 can store various types of information such as driving information for driving the motion pen 200, character information corresponding to a movement of the motion pen 200, contact number information, execution information for executing a function on the motion pen 200.

The controller 180 can control various operations of the motion pen 200. The operations of the motion pen 200 include any operation related to driving of the motion pen 200, such as an operation of executing or terminating a function on the motion pen 200, an operation of turning on or off power of the motion pen, or the like. For example, based on a movement sensed by the operation sensing unit 230, the controller 180 can generate a character and store the generated character in the memory unit 170. Also, the controller 180 can output the generated character on the display unit 151.

In another example, the controller 180 can terminate the operation sensing unit 230 such that an operation sensed by the operation sensing unit 230 is not generated as a character. In this instance, the sensors constituting the operation sensing unit 230 are deactivated not to sense an operation of the main body 210 of the motion pen 200 any longer. Here, a state in which the sensors are deactivated corresponds to a state in which current is not supplied to the sensors so the sensors are not functioning. Conversely, a state in which the sensors are activated corresponds to a state in which current is supplied to the sensors so the sensors are functioning.

Referring to FIG. 2B, the motion pen 200 includes a main body 210, the tip portion 220, and a button unit 250. The main body 210 of the motion pen 200 can extend in one direction and be formed as a hollow body. A battery may be installed on the main body 210. Also, the button unit 250, which may be drawn in and out, is provided on an outer circumferential surface of the main body 210 of the motion pen 200,

The button unit 250 can be attached to an outer circumferential surface of the main body 210 of the motion pen 200 and can be drawn in and out by an external force. The button unit 250 may be connected to sensors to start or terminate an operation of the sensors (or activate or deactivate the sensors). The starting of the operation (or activation) may be supplying a current to the sensors to control the sensors to sense sensor information, and the termination of the operation (or deactivation) may be stopping supply of current to the sensors to control the sensors not to sense sensor information.

For example, when the button unit 250 is drawn into the main body 210 of the motion pen 200 by an external force, the controller 180 can activate the sensors connected to the button unit 250. Also, when the button unit 250 is drawn out from the main body 210, the controller 180 can deactivate the sensors connected to the button unit 250.

The tip portion 220 is disposed at one end of the main body 210 of the motion pen 200. One end of the tip portion 220 protrudes outwardly so as to be in contact with a contact target (for example, paper, wall, an object allowing for handwriting input). Also, the other end of the tip portion 220 is positioned in an inner space of the main body 210 of the motion pen 200, and may be the third sensing unit 233.

One end of the tip portion 220 discharges ink to write or draw a character in a region in which the tip portion 220 of the pen is brought into contact with a contact target. Also, the tip portion 220 may be configured to allow for a touch input, rather than discharging ink. In this instance, the tip portion 220 may be formed of a material (that is, a conductor) allowing a current to flow so as to be sensed by a capacitive or resistive touch sensor. That is, the tip portion 220 may be formed to discharge ink, apply a touch to a contact target, or sense a touch input, and in addition, an ink discharging portion of the tip portion 220 from which ink is discharged and a touch sensing portion of the tip portion 220 may be switched by the user.

The other end of the tip portion 220 may be connected to the third sensing unit which senses pressure applied to the one end by an external force. In the above, the structure of the motion pen 200 according to an embodiment of the present disclosure has been described. Hereinafter, a disposition of the sensing unit of the motion pen according to an embodiment of the present disclosure will be described.

In order to sense a movement of the main body 210 of the motion pen 200 the pen 200 includes a first sensing unit 231 and a second sensing unit 232. The first sensing unit 231 can sense a rotational movement of the main body 210 of the motion pen 200, and the second sensing unit 232 can sense a linear movement of the main body 210 of the motion pen 200.

In order to sense a rotational movement of the main body 210 of the motion pen 200 with respect to a handwriting region, the first sensing unit 231 may be disposed at the other end of the main body 210 opposing one end in which the tip portion 220 is positioned. That is, in order to allow a length of a radius of a rotation for sensing a rotational movement to be used as a length of the main body 210 of the motion pen 200, the first sensing unit 231 may be disposed at the other end of the main body 210 of the motion pen. Meanwhile, the position of the first sensing unit 231 may be arbitrarily changed according to a design of a designer.

The second sensing unit 232 can correct a movement sensed by the first sensing unit 231. In more detail, the second sensing unit 232 can sense a linear movement which is not sensed by the first sensing unit 231 in order to accurately determine a movement of the main body 210. A specific method for correcting a movement of the main body 210 by the second sensing unit 232 will be described hereinafter.

Further, the second sensing unit 232 may include two or more sensors to correct a movement sensed by the first sensing unit 231. Also, the two or more sensors may be spaced apart from each other so as to be disposed in different positions. That is, by separately disposing the two or more sensors in different positions, data used for correcting a rotational movement of the main body 210 may be obtained.

For example, as illustrated in FIG. 3A, at least two or more sensors 232a and 232b forming the second sensing unit 232 can be disposed at both ends of the main body 210. In this instance, the controller 180 can obtain data indicating a movement of both ends of the main body 210 through the two or more sensors 232a and 232b and correct data indicating a movement of the first sensing unit 231 by using the data indicating the movement of both ends.

In another example, as illustrated in FIG. 3B, the two or more sensors 232a and 232b forming the second sensing unit 232 may be disposed in regions facing each other in relation to a fingering region 240 of the user who grasps the main body 210 of the motion pen 200. The fingering region 240 of the user is a region if the main body 210 reached by the user's fingers when the user performs handwriting using the motion pen 200. The fingering region 240 of the user can be previously set or may be changed according to a usage aspect (for example, a region of the main body 210 in which user's fingers are frequently sensed) of the user.

In the above, the disposition of the sensing unit for sensing a movement of the motion pen according to an embodiment of the present disclosure has been described. Hereinafter, a method for generating a character (or a letter) according to a movement of the motion pen will be described in detail with reference to the accompanying drawings.

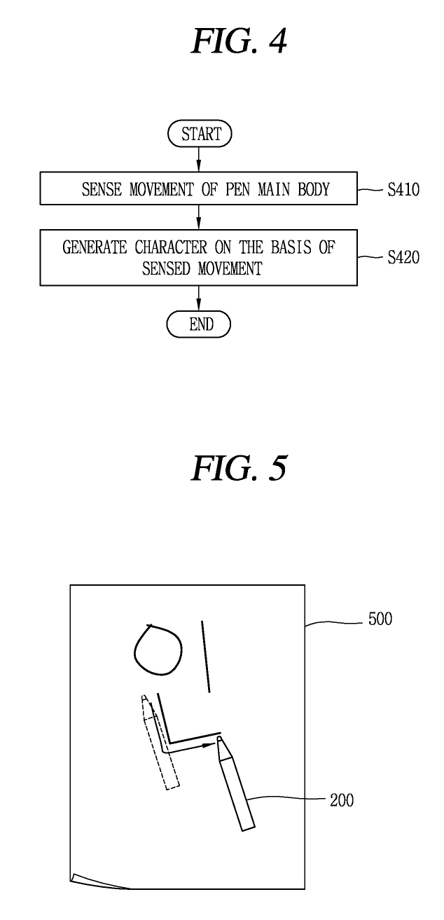

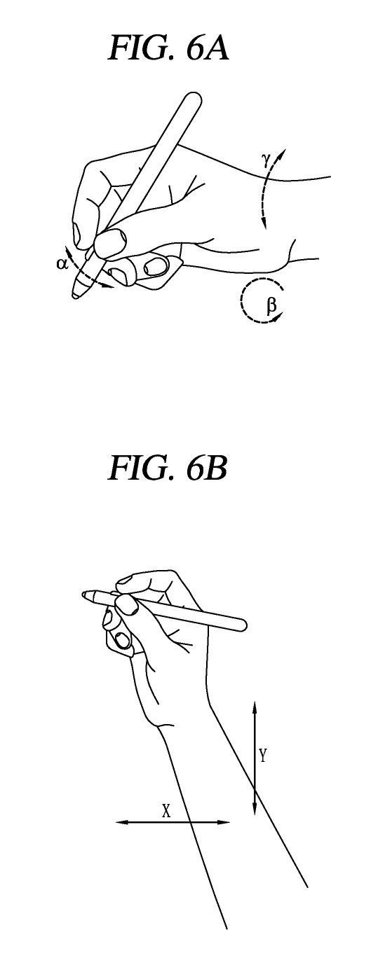

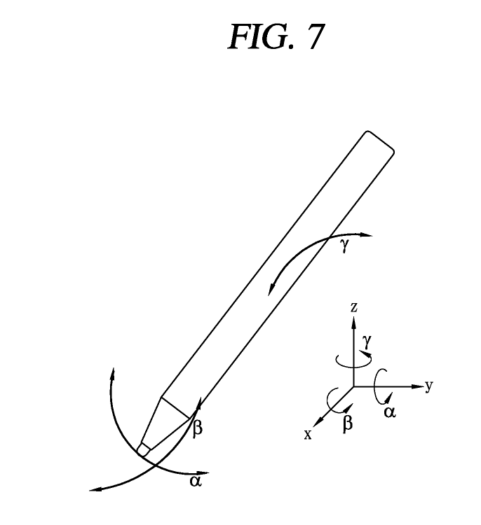

In particular, FIG. 4 is a flow chart illustrating a method of generating a character (or a letter) according to a movement of a motion pen according to an embodiment of the present disclosure, FIG. 5 is a conceptual view illustrating a control method of FIG. 4, and FIGS. 6A, 6B, and 7 are conceptual views illustrating a configuration of a movement of a motion pen.

In the motion pen 200 according to an embodiment of the present disclosure, the controller 180 can sense a movement of the main body 210 of the motion pen in step S410. When a preset condition is met, the controller 180 can sense a movement of the main body 210 of the motion pen 200. The preset condition may be a condition in which pressure applied to the tip portion 220 is equal to or greater than a preset pressure or a condition for receiving an input for generating a character from the user.

A movement of the pen main body 210 includes at least one of a rotational movement and a linear movement. A movement of the pen main body 210 will be described in more detail. The user can hold the pen main body 210 in his or her hand and write a character by applying an external force to the pen using a finger, wrist or a forearm.

In more detail, referring to FIG. 6A, the user can move the pen main body 210 to have a specific rotational angle (α) by using a vertical movement of the index finger. Also, the user can movement main body 210 to have a specific rotational angle (β) by using a rotation of the wrist based on the wrist as a rotation center. Also, the user can move the main body 210 to have a specific angle (γ) by using a horizontal movement of the wrist in relation to a direction in which the forearm is oriented.

Also, when the movement of FIG. 6A is viewed from the motion pen, it may be expressed as illustrated in FIG. 7. That is, the pen main body 210 can rotate to have the rotational angle (β) based on an x axis as a rotational axis, or rotate to have the rotational angle (α) based on a y axis a rotational axis, or rotate to have the rotational angle (γ) based on a z axis as a rotational angle.

Also, referring to FIG. 6B, the user can linearly move the pen main body 210 based on at least one of the x axis and the y axis. The x axis represents a reference direction used for sensing a linear movement of the pen main body 210 in a horizontal direction made by a horizontal movement of the elbow and the shoulder, and the y axis is a reference direction used for sensing a linear movement of the pen main body 210 in a vertical direction made by a vertical movement of the elbow and the shoulder.

For example, the user can move the pen main body 210 to have a first distance in the x axis direction, or move the pen main body 210 to have a second distance in the y axis direction. Also, the user can move the pen main body 210 by a third distance in a diagonal direction with respect to the x axis and the y axis to have the first distance in the x axis direction and the second distance in the y axis direction.

When the movement of the pen main body is sensed, the controller 180 can generate a character based on the sensed movement in step S420. When the movement of the movement of the main body 210 is sensed, the controller 180 can generate a character related to the movement.

The character includes a phoneme including a consonant and a vowel, a syllable, a morpheme, a word, a syntactic word, a paragraph, and a sentence. The phoneme refers to a minimum unit of phonemics which cannot be divided any further. The syllable refers to a unit of a voice providing a feeling of a synthesized sound, and the morpheme refers to a smallest unit having a meaning. Further, the word refers to a unit of language having a dependent meaning without separation. The syntactic word refers to a word forming a sentence, a minimum unit of a sentence component, or a unit of spacing. Also, the paragraph is a unit including a phrase and a sentence. The phrase is a sequence of two or more words, and the paragraph may be a unit including a subject and a predicate. Also, the sentence refers to a minimum unit indicating complete contents.

That is, the controller 180 can generate a phoneme, a syllable, a morpheme, a word, a syntactic word, a paragraph, and a sentence through a movement of the pen. For example, as illustrated in FIG. 5, the controller 180 can sense a movement of the main body 210 as the tip portion 220 is in contact with a contact target 500 and moves to generate a character. In more detail, the user can contact the tip portion 220 to the contact target 500 to write a character. Here, the contact target 500 may be an object on which handwriting with ink can be performed+.

In this instance, when the tip portion 220 contacts the contact target 500 and writes a character “ [symbol] ”, the controller 180 can generate the character “ [symbol] ” according to a movement of the main body 210, and store the same in the memory unit 170. Meanwhile, even though the main body 210 is moved, the controller 180 can control the operation sensing unit 230 not to generate a character any longer. That is, the controller 180 does not generate a character even though the main body 210 is moved.

In more detail, when a user's control command for terminating generation of a character is applied, when pressure is not sensed at the end of the tip portion 220 for more than a preset period of time, or when the main body 210 is not moved for more than a preset period of time, the controller 180 can deactivate the operation sensing unit 230. Here, when the operation sensing unit 230 is deactivated, the motion pen 200 does not sense a movement of the main body 210 any longer.

In the above description, the method for generating a character by using a movement of the main body of the motion pen according to an embodiment of the present disclosure has been described. Hereinafter, a method for correcting a movement of the main body for generating a character in the motion pen according to an embodiment of the present disclosure will be described in detail.

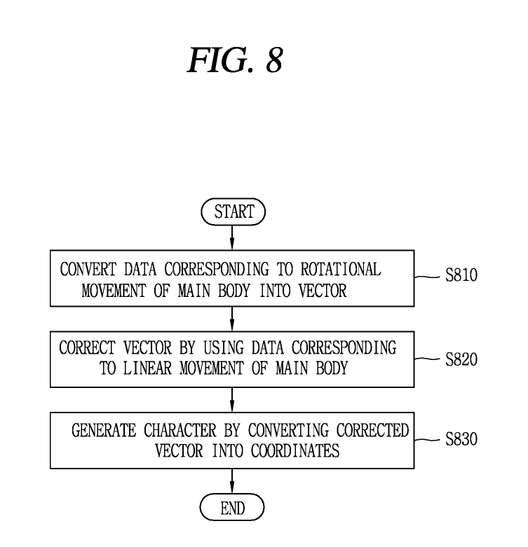

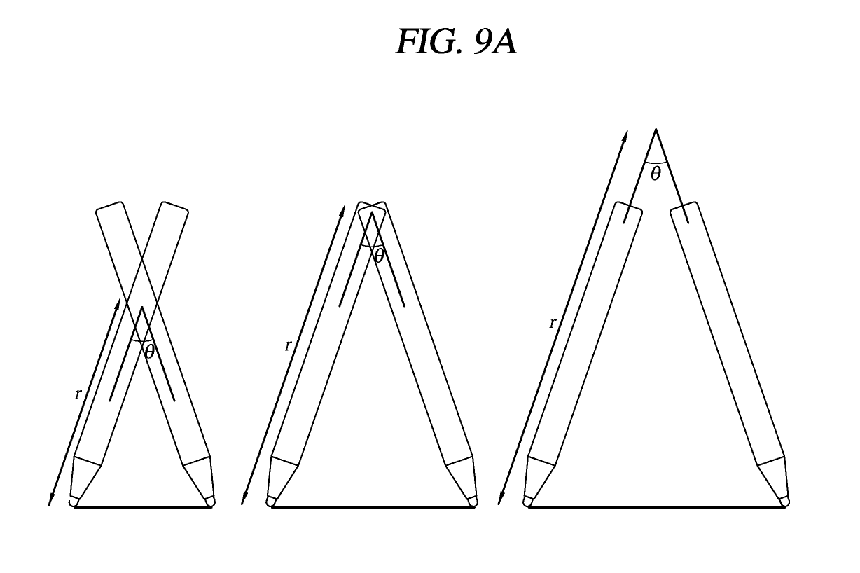

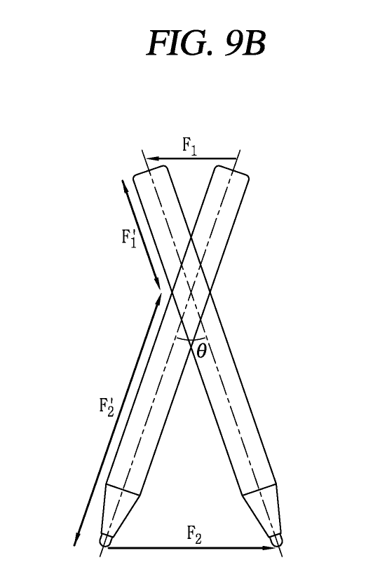

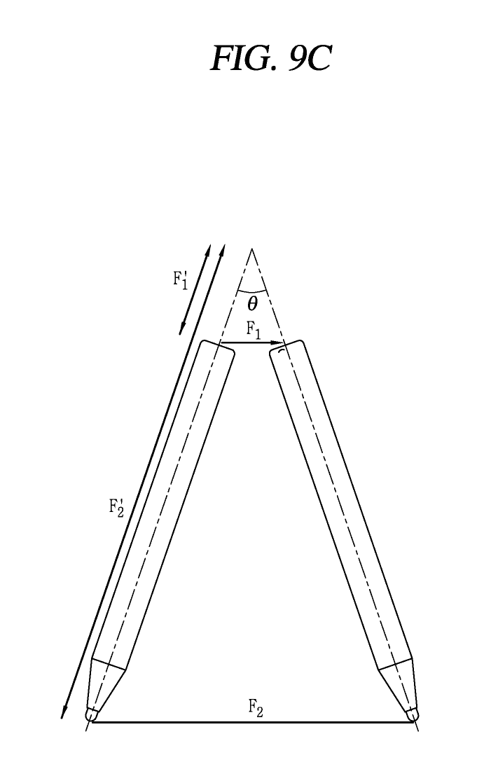

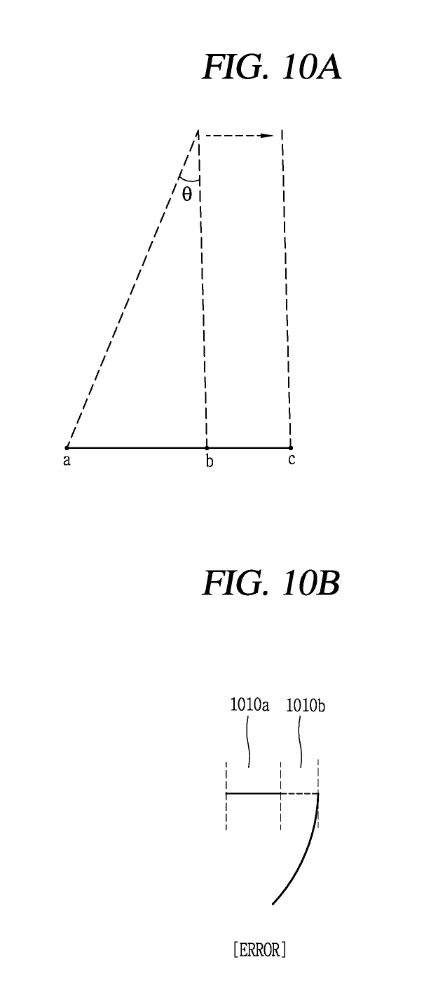

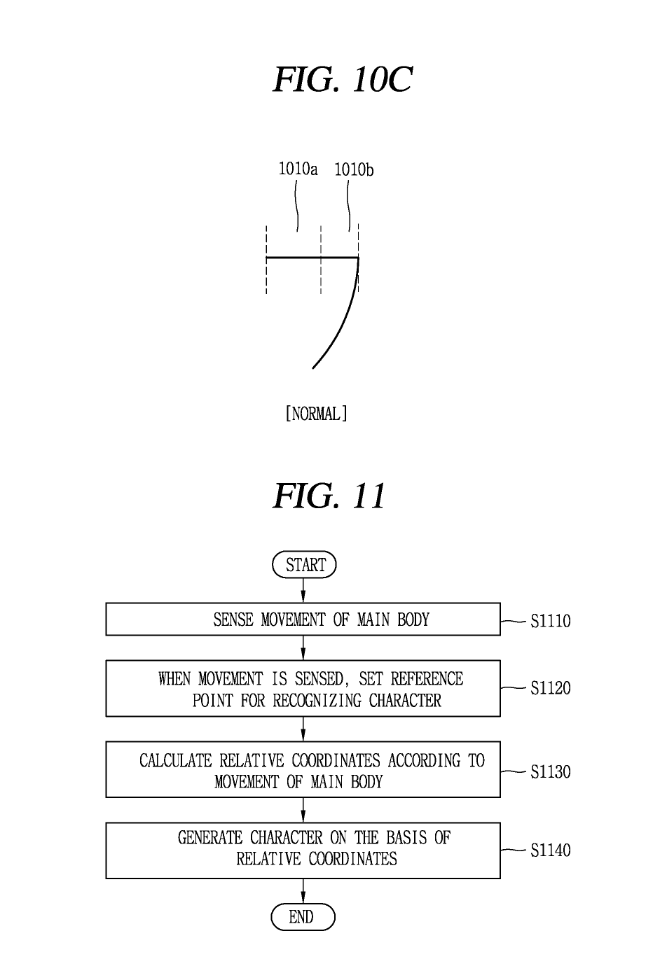

In particular, FIG. 8 is a flow chart illustrating a method for correcting a movement of a main body, FIGS. 9A, 9B, and 9C are conceptual views illustrating a rotational movement and a linear movement, and FIGS. 10A, 10B, and 10C are conceptual views illustrating a method for generating a character by correcting a movement of the main body.

In the motion pen according to an embodiment of the present disclosure, when a movement of the main body 210 is sensed, the controller 180 can receive data corresponding to a rotational movement of the main body 210 and convert the received data into a vector in step S810. When a preset condition is met, the controller 180 can sense a rotational movement of the main body 210 through the first sensing unit 231. The preset condition may be a condition for recognizing a movement of the main body 210 as a movement for generating a character. For example, the preset condition may be a condition under which pressure equal to or greater than a preset value is sensed at the end of the tip portion 220.

The first sensing unit can sense a rotation angle of the main body 210 based on a plurality of preset axes. Thereafter, the controller 180 can obtain linear velocity by multiplying a preset length of the sensed rotation angle based on each axis. Also, through the linear velocity, the controller 180 can calculate a two-dimensional (2D) vector corresponding to the movement of the main body 210. The 2D vector may be a value having a size and a direction. Hereinafter, the 2D vector will be referred to as a vector for the sake of convenience, and the vector value may be understood as including a size and a direction of the vector.

For example, the controller 180 can sense the first rotation angle (β) based on the x axis, the second rotation angle (α) based on the y axis, and a third rotation angle (γ) based on the z axis. Thereafter, the controller 180 can calculate a linear velocity (V_{L}) of each angle by multiplying a preset length (radius) to each of the first, second, and third rotation angular velocities (Vₐ) as expressed by Equation 1. The preset length may be a length of the main body 210 or a length between the pen and the wrist based on a size of a general hand. The size of the general hand may refer to a size of an average hand of adult.

|V_{L}=Vₐ×Radius (Equation 1)

(V_{L}: linear velocity, Vₐ: angular velocity, Radius: rotation radius)

In more detail, the controller 180 can calculate a first linear velocity and a second linear velocity by multiplying the length of the main body 210 to first and second rotation angles. Also, the controller 180 can calculate a third linear velocity by multiplying the length between the pen and the wrist to the third rotation angle.

Thereafter, the controller 180 can calculate a first vector value by using a value of the sum of the first linear velocity and the third linear velocity as a horizontal component and the second linear velocity as a vertical component through Equation 2 below.

V=\sqrt{(V_{β}+V_{γ})²+V_{α}²} (Equation 2)

(V: first vector value, V_{β}: first linear velocity, V_{α}: second linear velocity, V_{γ}: third linear velocity)

Meanwhile, since the first sensing unit senses a rotational movement of the main body 210 under the assumption that movements of every object has the same rotation radius, the first sensing unit can recognize a movement having the same rotation angle as a vector having the same length (or size). That is, when the rotation angle is the same, the first sensing unit 231 may recognize different movements having different rotation radii, as the same movement.

For example, as illustrated in FIG. 9A, regarding three different movements having the same rotation angle (θ) but different rotation radii (r), the controller 180 can regard (or recognize) the three different movements as the same movement having the same rotation angle. That is, since the controller 180 recognizes the movements corresponding to vectors having different lengths as the same movement, the controller 180 erroneously recognizes the vector as having the same length. Thus, the controller 180 generates an erroneous character with the rotation movement sensed by the first sensing unit.

Thus, the motion pen according to an embodiment of the present disclosure corrects the vector value corresponding to the rotational movement through a linear movement of the main body 210 in step S820. The sensing unit 200 includes the second sensing unit 232 for sensing a linear movement of the main body 210. The second sensing unit 232 may include at least two sensors 232a and 232b, and the at least two sensors 232a and 232b may be disposed to be spaced apart from one another.

For example, the second sensing unit 232 may include a first sensor 232a and a second sensor 232b. The first sensor 232a and the second sensor 232b can be spaced apart from one another and disposed at both ends of the main body 210. After the controller 180 generates a first vector value indicating a movement sensed by the first sensing unit 231, the controller 180 can correct the first vector value by using the first data received from the first sensor 232a and the second data received from the second sensor 232b.

In more detail, the controller 180 can correct a linear velocity of the first vector by using a ratio of the first data and the second data. Here, the ratio of the first data and the second data may be a value for correcting a preset length, that is, a length of the main body 210, multiplied to the angular velocity. The ratio of the first data and the second data is shown by Equation 3 below.

$${V}_{new} = {V}_{old} \times \frac{F 2}{F 2 \pm F 1} \qquad ( Equation 3 )$$

(V_{new}: corrected linear velocity value, V_{old}: linear velocity value before correction, F1: vector value of first data value received from first sensor, F2: vector value of second data value received from second sensor). Here, F1 and F2 are vector values which may be positive (+) when a direction of F1 and a direction of F2 are the same and which may be negative (−) when the direction of F1 is different from that of F2, with respect to the direction of F2.

For example, as illustrated in FIG. 9B, a direction of first data value received from the first sensor and a direction of a second data value received from the second sensor are different. Here, the controller 180 can correct a preset length of the main body 210 by using a ratio of the vector value F2 of the second data value to a value obtained by subtracting a vector value F1 of the first data value from the vector value F2 of the second data value. Thereafter, the controller 180 can correct the first and second linear velocity values by using the corrected length of the main body 210.

In another example, as illustrated in FIG. 9C, a direction of a first data value received from the first sensor and a direction of a second data value received from the second sensor are the same. Here, the controller 180 can correct the preset length of the main body 210 by using a ratio of the vector value F2 of the second data value to a value obtained by adding the vector value F1 of the first data value to the vector value F2 of the second data value. Thereafter, the controller 180 can correct the first and second linear velocity values by using the corrected length of the main body 210.

Thus, the controller 180 can calculate the preset length of the main body 210 by using the ratio of the vector value F2 of the second data value to the value obtained by adding the vector value F2 of the second data value and the vector value F 1 of the first data value. Thereafter, the controller 180 can correct the first and second linear velocity values by using the corrected length of the main body 210.

Thus, the controller 180 can generate a character according to a movement of the main body 210 of the motion pen 200 by correcting a linear movement of the main body 210 which is not sensed as a rotational movement of the main body 210 in step S830. Also, in another example, when a movement of the main body 210 includes a rotational movement and a linear movement, the controller 180 can generate a character by combining characters of forms corresponding to each of the movements.

For example, as illustrated in FIG. 10A, when a movement of the main body 210 includes a rotational movement and a linear movement, the controller 180 can generate a character by combining characters of forms correspond to each of the movements. In more detail, as illustrated in FIG. 10A, the controller 180 can sense a movement of the main body 210. Here, the movement of the main body 210 include a rotational movement made from a to b and a linear movement made from b to c.

In this instance, the controller 180 can sense the rotational movement from a to b through the first sensing unit 231 to calculate a first vector value with respect to the rotational movement, and calculate a second vector value with respect to the linear movement made from b to c through the second sensing unit 232. The controller 180 can generate a character by calculating a third vector value by adding the first vector value and the second vector value. For example, as illustrated in FIG. 10C, the controller 180 can generate “ [symbol] ” by combining a first portion 1010a corresponding to the first vector value and a second portion 1010b corresponding to the second vector value.

Meanwhile, as illustrated in FIG. 10B, when the second sensing unit 232 is not provided so the second vector value is not sensed, the character portion 1010b corresponding to the second vector value is not generated. In this instance, the controller 180 can determine that an error has occurred, and sense again a movement of the main body 210 or transmit notification information indicating that a character has not been generated, to the user.

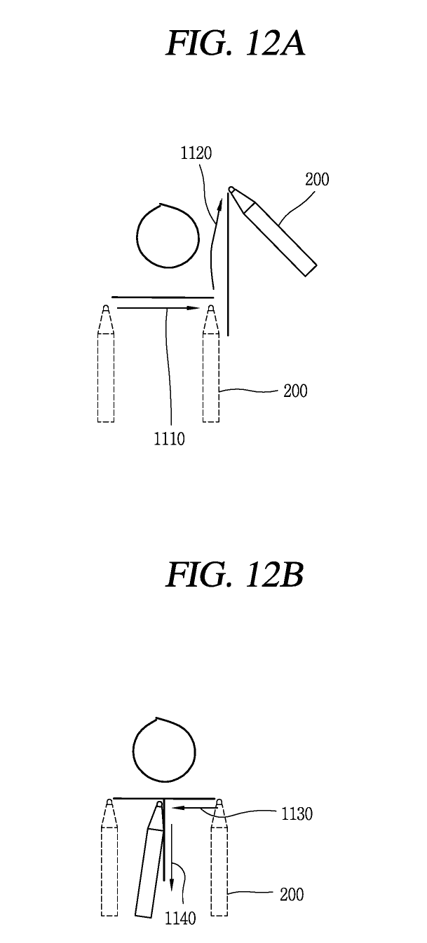

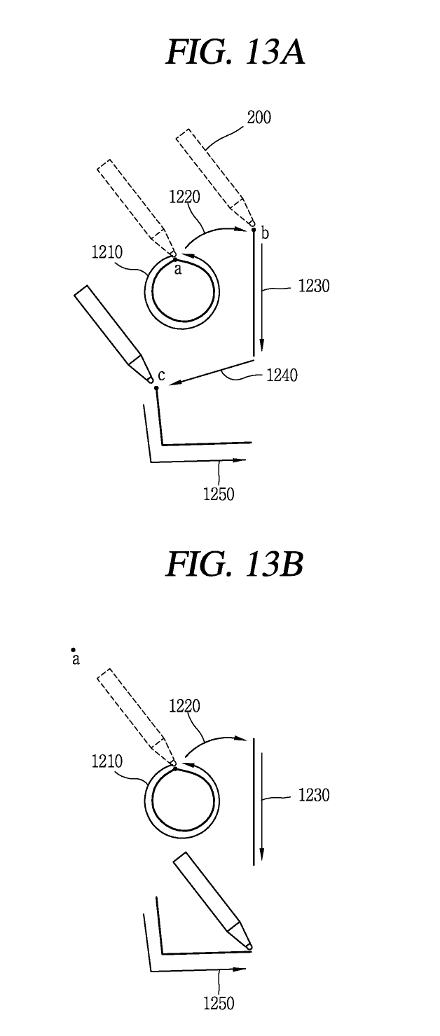

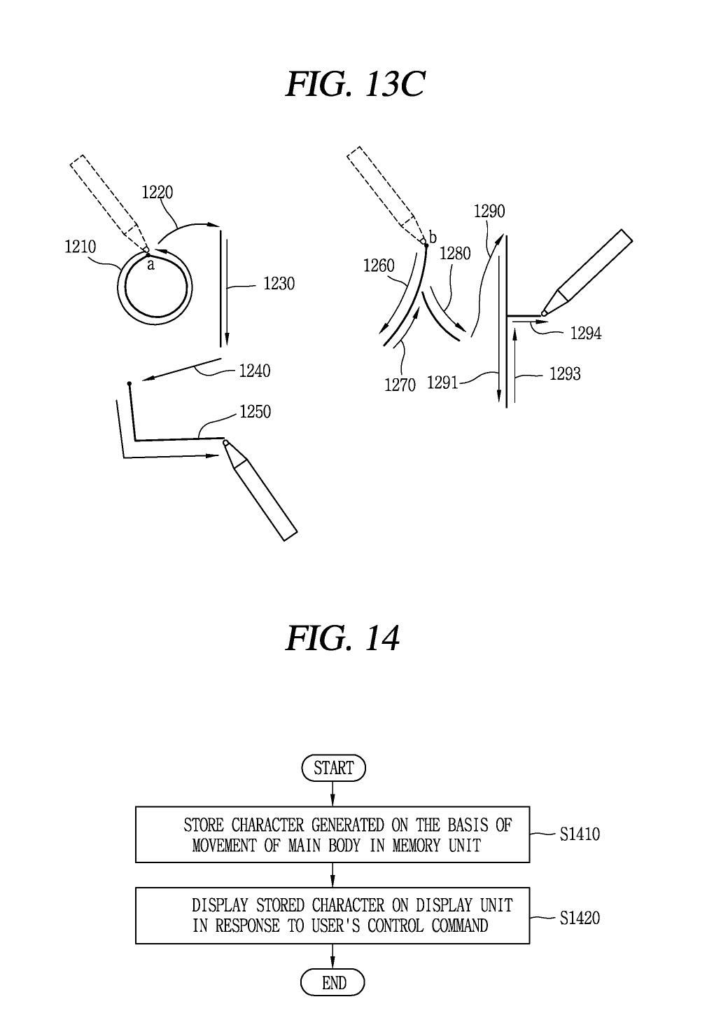

In the above, the method for sensing a rotational movement and a linear movement of the main body and correcting the rotational movement with the linear movement has been described. Hereinafter, a method for generating a character according to the corrected movement will be described in detail. In particular, FIG. 11 is a flow chart illustrating a method for generating a character according to a movement of the main body, FIGS. 12A and 12B are conceptual views illustrating a method for generating a character according to the flow chart of FIG. 11, and FIGS. 13A, 13B, and 13C are conceptual views illustrating a method for setting a reference point.

The motion pen 200 according to an embodiment of the present disclosure can generate a character by using a movement of the main body 210 and store the generated character in the memory unit 170. Thus, the controller 180 can sense a movement of the main body in step S1110. The movement of the main body can be sensed as described above with reference to FIG. 8. This, in the present disclosure, a description of sensing of a movement of the main body will be replaced with the description of FIG. 8.

Meanwhile, a movement of the main body 210 may include both a movement contacting a contact target and a movement not contacting the contact target. That is, the controller 180 can sense both a first movement contacting a contact target of the main body 210 and a second movement not contacting the contact target through the first sensing unit 231 and the second sensing unit 232.

In more detail, as illustrated in FIG. 12A, a movement of the main body 210 may include a first movement 1110 contacting a contact target and a second movement 1120 not contacting the contact target. Here, the controller 180 can determine whether the movement of the main body 210 is a movement contacting the contact target or a movement not contacting the contact target based on pressure applied to the tip portion 220 of the main body 210. Through this information, the controller 180 can determine relative positions of the phonemes.

For example, as illustrated in FIG. 12A, with respect to movements 1110 and 1120 generating “ [symbol] ” and “ [symbol] ”, the controller 180 can generate “ [symbol] ” through the second movement 1120 not applied to the contact target. In another example, as illustrated in FIG. 12B, with respect to movements 1130 and 1140 generating “ [symbol] ” and “ [symbol] ”, the controller 180 can generate “ [symbol] ” through the second movement 1140 not applied to the contact target.

That is, the controller 180 can determine relative positions of phonemes with respect to movements of the main body 210 by sensing a movement not in contact with the contact target, as well as the movement in contact with the contact target, thereby generating a character. Meanwhile, when a movement of the main body 210 is sensed, the controller 180 can set a reference point for generating a character in step S1120.

The controller 180 can convert a vector value corresponding to the movement of the main body 210 corresponding to the sensed movement of the main body into relative coordinates. Also, the controller 180 can generate a character by using each relative coordinate value.

Meanwhile, in order to generate a character by using the relative coordinates value, the controller 180 need to convert the relative coordinates into absolute coordinates. Thus, the motion pen 200 according to an embodiment of the present disclosure may set a reference point for converting the relative coordinates into absolute coordinates. The reference point may be a virtual reference for converting the relative coordinates calculated in the motion pen 200 into absolute coordinates.

The reference point may be set when a movement of the motion pen 200 is a movement for generating a character. For example, when it is sensed that pressure equal to or greater than a preset value is applied to one end of the tip portion 220 of the motion pen 200, the reference point may be set. In another example, when a user's control command for generating a character is received, the controller 180 can set the reference point. The user's control command for generating a character may be received in various manners. For example, the control command may include a control command by a voice, a control command by a touch, a control command by pressure of the button unit, and the like.

The reference point may be set based on a preset condition. The preset condition may be a condition related to a point in time at which preset pressure is first applied to the tip portion 220, a condition related to a preset time, a condition related to a point in time at which pressure is not applied to the tip portion 220, a condition in which a control command for setting a reference point is applied, and a condition in which a control command for generating a character is applied.

For example, the controller 180 can set a position corresponding to a start point in time at which pressure is applied to the tip portion 220, to a reference point. The position corresponding to a point in time at which pressure is applied to the tip portion 220 may be a position in which the tip portion 220 contacts the contact target or a position apart from the position in which the tip portion 220 contacts the contact target by a predetermined distance.

For example, as illustrated in FIG. 13A, the controller 180 can set regions a, b, and c in which the tip portion 220 is positioned at a point in time at which pressure is applied to the tip portion 220, in the entire region of the contact target, to reference points. In another example, as illustrated in FIG. 13B, the controller 180 can set a position “a” (first reference point) apart from the point in time at which pressure is applied to the tip portion 220 by a preset distance, in the entire region of the contact target, to a first reference point.

In another example, as illustrated in FIG. 13C, after the reference point was set in the entire region of the contact target, when a preset period of time has lapsed, the controller 180 can set a region (a or b) in which the tip portion 220 is positioned, to a reference point. When the reference point is set, the controller 180 can generate a character by using a movement of the pen main body 210 in step S1140.

When the reference point is set, the controller 180 can convert relative coordinates indicating a movement of the pen main body 210 into absolute coordinates with respect to the reference point. Here, when a preset condition is set, the controller 810 may generate a character based on the absolute coordinates.

The preset condition may be any one of a condition in which a preset period of time has lapsed after the reference point was set, and a condition in which pressure is not sensed in the tip portion 220. When the condition in which a preset period of time has lapsed after a reference point was set, the controller 180 can sense that pressure is not applied to the tip portion while the relative coordinates representing the movement of the pen main body 210 are being converted into absolute coordinates.

Here, when it is sensed that pressure is not applied to the tip portion 220, the controller 180 can determine whether a preset period of time, starting from the set point in time of the reference point, has lapsed. When the preset period of time, starting from the set point in time of the reference point, has not lapsed according to the determination result, the controller 180 does not initialize the relative coordinates, the absolute coordinates, and the reference point, and continuously converts the relative coordinates representing the movement of the pen main body 210 into absolute coordinates with respect to the set reference point.

Meanwhile, when the preset period of time, starting from the set point in time of the reference point, has lapsed according to the determination result, the controller 180 can generate a character based on the absolute coordinates representing the movement of the pen main body 210 during the preset period of time after the setting of the reference point. Also, the controller 180 can initialize the relative coordinates, the absolute coordinates, and the reference point corresponding to the movement of the main body 210. Here, initializing the relative coordinates and the absolute coordinates may refer to deleting the relative coordinates and the absolute coordinates detected before the initialization from the memory. Also, the initializing the reference point may refer to resetting the reference point set before the initialization into a new reference point.

For example, as illustrated in FIG. 13C, the controller 180 can set a position (“a”, the first reference point) corresponding to a point in time at which pressure was first applied to the tip portion 220, to a reference point, and sense a movement of the main body 210. The controller 180 can convert relative coordinates representing movements 1210, 1220, 1230, 1240, and 1250 of the main body 210 into absolute coordinates with respect to the reference point.

Thereafter, when it is sensed that pressure is not applied to the tip portion 220, the controller 180 can determine whether a preset period of time, starting from the set point in time of the reference point, has lapsed. When the preset period of time, starting from the set point in time of the reference point, has lapsed according to the determination result, the controller 180 can generate a character of “ [symbol] ” based on the absolute coordinates representing the movements 1210, 1220, 1230, 1240, and 1250 of the main body 210. Also, the controller 180 can initialize the relative coordinates, the absolute coordinates, and the reference point.

Thereafter, when pressure is applied again to the tip portion 220, the controller 180 can initializes the reference point corresponding to the position (“a”, first reference point) corresponding to a point in time at which pressure was first applied, and set a position (“b”, second reference point) corresponding to a point in time at which pressure is applied again, to a reference point. The controller 180 can generate a character “ [symbol] ” based on movements 1260, 1270, 1280, 1290, 1291, 1292, 1293, and 1294 of the main body 210 with respect to the position (“b”, second reference point) corresponding to a point in time at which the pressure was applied.

Meanwhile, when the preset period of time, starting from the set point in time of the reference point, has not lapsed according to the determination result, the controller 180 can determine that the movements of the main body 210 for generating “ [symbol] ” have not been completed yet, and not generate a character with respect to the absolute coordinates representing the movements of the main body 210. Here, the controller 180 can perform a process of continuously sensing a movement of the main body 210 and converting the movements into relative coordinates and absolute coordinates.

Meanwhile, in the above, when the preset period of time is measured after the set point in time of the reference point has been described. However, the aforementioned control scheme according to the present disclosure may also be applied to when a preset period of time is measured after a point in time at which pressure is not applied to the tip portion 220, in the same manner.

When the preset condition is a condition in which pressure is not sensed in the tip portion 220, the controller 180 can generate characters by using relative coordinates and absolute coordinates representing a movement of the pen main body 210 whenever pressure is not applied to the tip portion 220. Also, the controller 180 can initialize the relative coordinates, the absolute coordinates, and the reference point. For example, as illustrated in FIG. 13A, the controller 180 can set a position in which pressure is first applied to the tip portion 220, to a reference point (“a”, a first reference point), extract relative coordinates representing “o” by using the movement 1210 of the main body 210, and generate absolute coordinates with respect to the reference point.

Here, when it is sensed that pressure is not applied to the tip portion 220, the controller 180 can generate a character based on the relative coordinates and the absolute coordinates representing the movement 1210 of the main body 210. Also, the controller 180 can initialize the relative coordinates, the absolute coordinates, and the reference point.

After the initialization is performed, when pressure is not sensed in the tip portion 220, the controller 180 can sense that pressure is applied to the tip portion 220 again. Here, the movement 1230 of the main body 210 may be a movement for drawing “ [symbol] ”. In this instance, the controller 180 can set the position (“b”, second reference point) when the pressure is applied again, to a reference point. That is, the reference point used for generating “o” is initialized so the reference point may be changed to the position when the pressure is applied again. The controller 180 can calculate relative coordinates and absolute coordinates corresponding to “ [symbol] ” by using the position (“b”, second reference point) when the pressure is applied again).

Here, when pressure is not sensed again in the tip portion 220, the controller 180 can generate a character with respect to the relative coordinates and the absolute coordinates representing the movement 1230 of the main body 210. Meanwhile, unlike the case of FIG. 13C, after the initialization of the reference point, the controller 180 can set the position (a) corresponding to the point in time at which the pressure was first applied to the tip portion 220, to a reference point again, rather than setting the position when the pressure is applied again to a reference point. In this instance, the controller 180 can calculate relative coordinates and absolute coordinates corresponding to the movement 1230 of the main body 210 based on the reference point set again.

Also, the controller 180 can recognize a character in units of phoneme or in units of morpheme, and generate a letter, a word, a sentence, and a paragraph by using the recognized character. An algorithm for generating such a letter, word, sentence, and paragraph may be implemented through the related art “Eulerian path” (or Eulerian trail) scheme and various character generation algorithms.

In the above, the method for converting relative coordinates representing the movement of the main body 210 into absolute coordinates with respect to a virtual reference point has been described. Thus, in the present disclosure, the motion pen can generate and store a character by itself without the necessity of an additional device for converting relative coordinates into absolute coordinates.

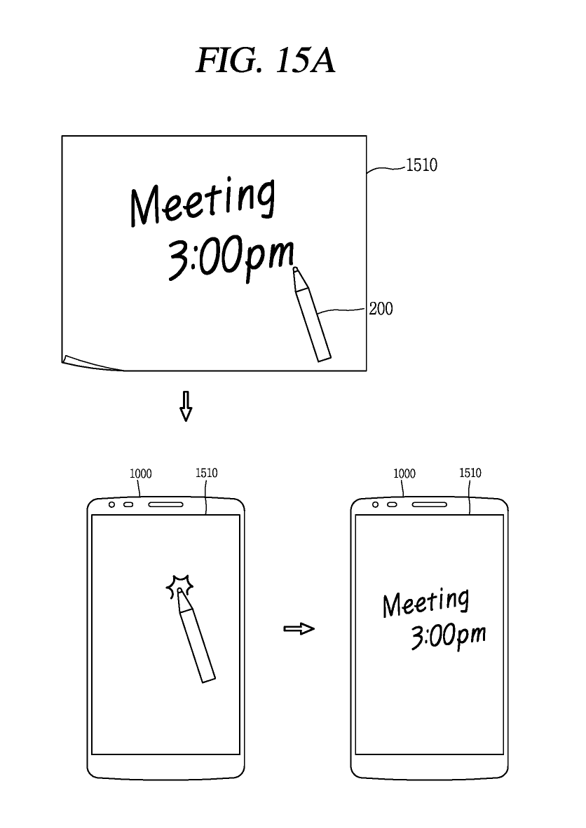

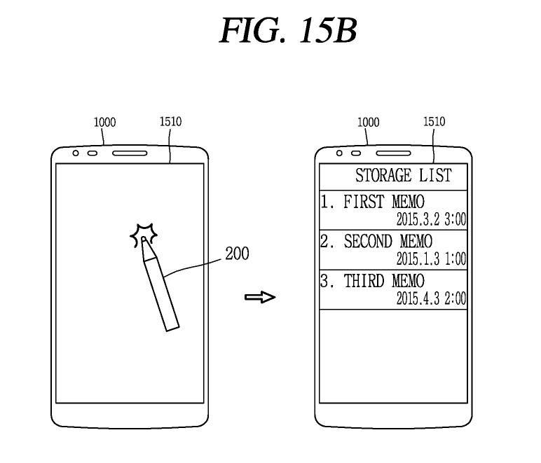

Hereinafter, a method for generating a character by using a motion pen and outputting the generated character will be described. In particular, FIG. 14 is a flow chart illustrating a method for generating a character using a motion pen and outputting the generated character, and FIGS. 15A and 15B are conceptual views illustrating the control method of FIG. 14.

In the motion pen according to an embodiment of the present disclosure, based on a movement of the main body of the motion pen, the controller may store a generated character in a memory unit in step S1410. The motion pen 200 may further include the memory unit 170 storing data. The memory unit 170 may store various types of information such as information related to an operation of the motion pen 200.

Information related to an operation of the motion pen 200 may include driving information of the motion pen 200, execution information of functions stored in the motion pen 200, and driving information of the components (for example, a communication unit and a display unit) provided in the motion pen 200. Also, information related to various functions that may be provided by the motion pen, such as image information, character information, and document information. Also, in response to a user's control command, the controller 180 can output the stored character on the display unit provided in the motion pen 200 or on a display unit of an external device in step S1420.

The motion pen 200 according to an embodiment of the present disclosure may communicate with an external device. The external device may be various terminals including a communication unit through which the external device can communicate with the motion pen 200, such as a mobile terminal, a tablet, a connected car, a projector, a smart refrigerator, or a smart boiler.

The user's control command may be received in various manners. For example, the user's control command may be received in various manners such as a voice command, a touch command, a gesture command, a button input, or a command based on a pattern input. In more detail, in response to a user's control command, the controller 180 can output a character generated according to a movement of the motion pen 200 on the display unit 1510 of the mobile terminal 1000.

For example, as illustrated in the left lower drawing of FIG. 15A, when an operation of tapping the mobile terminal 1000 is applied by using the motion pen 200, the controller 180 can transmit character information to the mobile terminal 1000. The mobile terminal 1000, to which the tap has been applied, receives a contact signal from the tip portion 220 through proximity or contact, and transmits a response signal with respect to the contact signal, thus performing communication with the motion pen 200.

As illustrated in the right lower drawing of FIG. 15A, upon receiving the character information, the mobile terminal 1000 may output the character information on the display unit 1510 provided in the mobile terminal 1000. Meanwhile, as for the user's control command, various types of control commands may be implemented, in addition to the control command illustrated in the drawings.

In addition, when a plurality of pieces of character information is received, the mobile terminal 1000 may output a list including items representing the plurality of pieces of character information on the display unit 1510. For example, as illustrated in the left drawing of FIG. 15B, when a tap applied to the mobile terminal 1000 is sensed, the mobile terminal 1000 may receive a plurality of pieces of character information from the motion pen 200 which has applied the tap.

Thereafter, as illustrated in the right drawing of FIG. 15B, the mobile terminal 1000 may display a list including items representing a plurality of pieces of character information on the display unit 1510. In this instance, the user can know the character information received from the motion pen 200, and in addition, may provide character information through the display unit 1510.

Also, after character information is transmitted to the external device, the controller 180 can receive a feedback signal (or a response signal) indicating that the character information has been successfully transmitted. Here, when the feedback signal indicating that the character information has been successfully received by the external device is not received, the controller 180 can continuously transmit the character information until when the response signal is received, and may output notification information indicating that the character information has not been transmitted to the user.

Meanwhile, the motion pen 200 may output character information to an external device, and may output character information on the display unit provided in the motion pen 200. Here, the controller 180 can provide character information through the display unit provided in the motion pen 200. In the above, the method for providing character information generated through the motion pen has been described. Hereinafter, a method for executing a function associated with character information generated through the motion pen will be described.

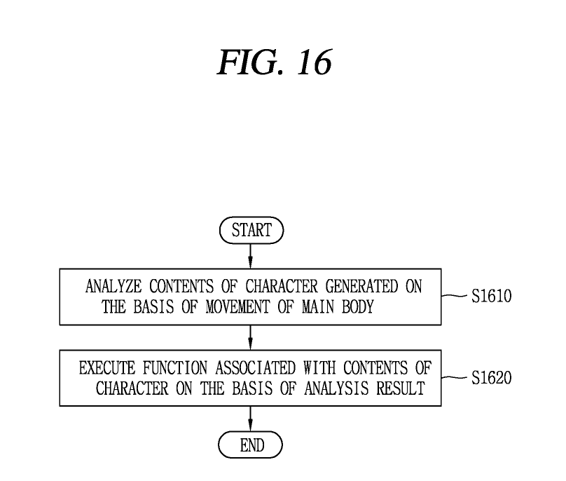

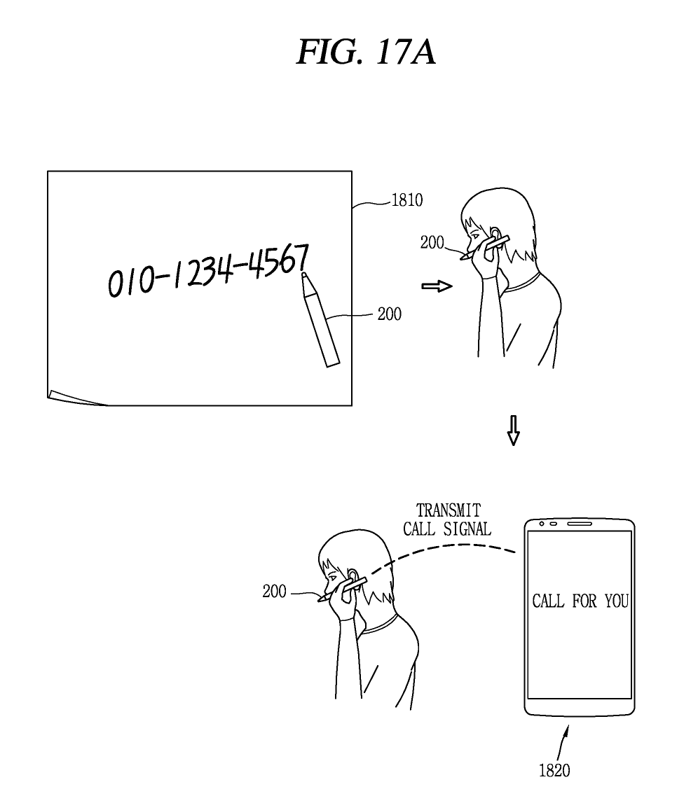

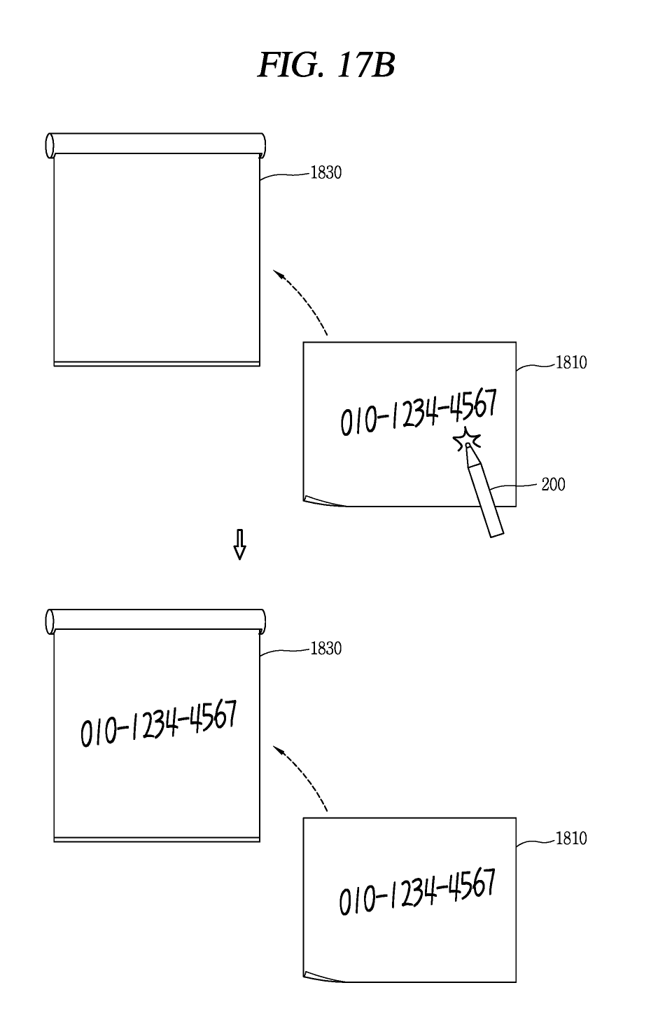

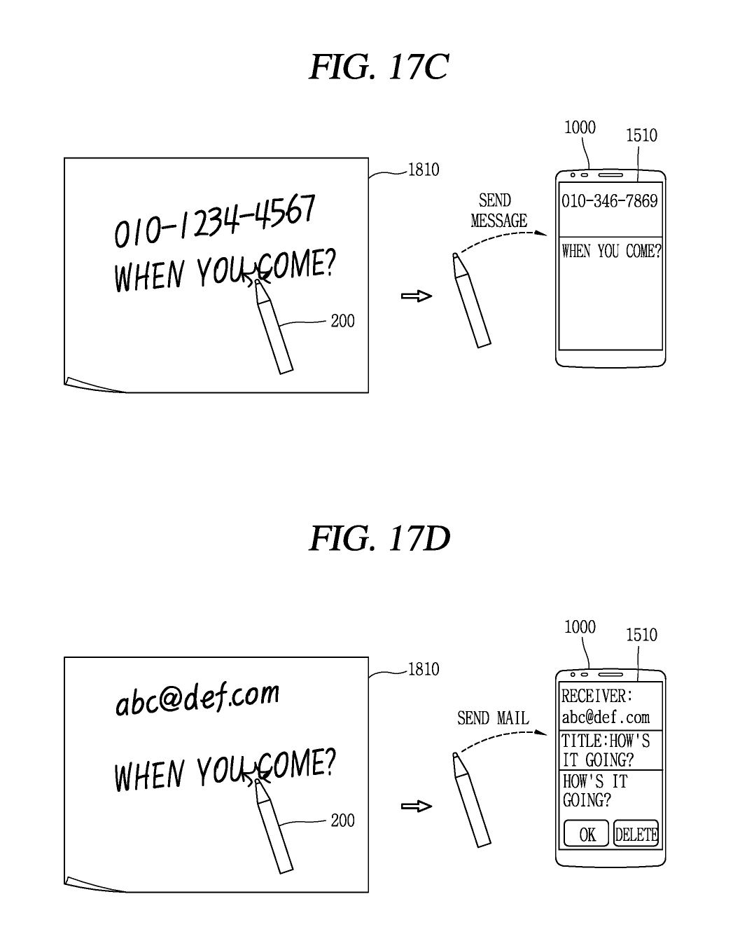

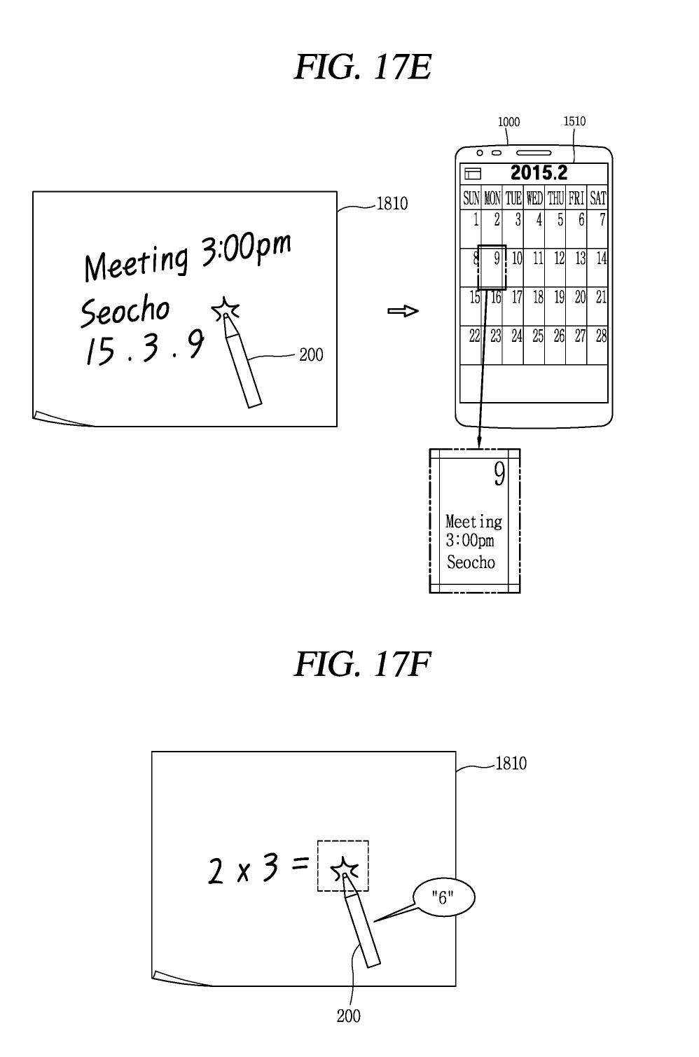

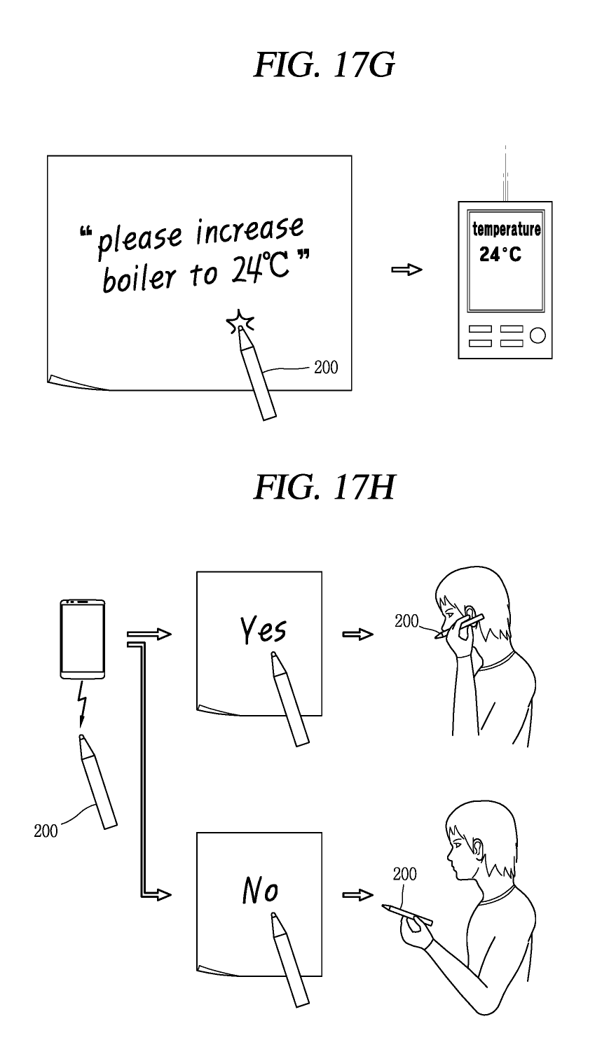

FIG. 16 is a flow chart illustrating a method for executing a function associated with character information generated through a motion pen, and FIGS. 17A, 17B, 17C, 17D, 17E, 17F, 17G, and 17H are conceptual views illustrating the control method of FIG. 16. In the motion pen 200 according to an embodiment of the preset invention, the controller 180 can analyze contents of a character generated based on a movement of the main body of the motion pen 200 in step S1610.

When a character is generated based on a movement of the main body of the motion pen 200, the controller 180 can analyze contents of the character based on a user's control command. In analyzing the contents of the character, whether the character is identical to a previously stored control command, whether a specific word is included in the character, whether the character is a number, whether the character includes a special symbol, a sentence structure such as postposition, and word spacing.

For example, the controller 180 can store a plurality of control commands in the memory unit 170 in advance, and compare the character with the plurality of stored control commands and determine whether they are identical, thus analyzing the contents of the character. In more detail, when a character “yes” stored in the memory unit 170 is connected to a call signal reception function, the controller 180 can determine whether the generated character is identical to the character “yes”, and when the generated character is identical to “yes”, the controller 180 can control the motion pen 200 to receive the call signal function.

In another example, when the character includes a number and a symbol, the controller may determine whether the character is a phone number, a date, an amount of money, or general number data. In more detail, when 10-digit numbers and a dash symbol, that is, “−”, are recognized, the controller 180 can recognize the character as a phone number. Also, when a symbol “@” is recognized, the controller 180 can recognize that the character indicates an e-mail address.

In another example, the controller 180 can recognize a specific word and analyze contents of the character. In more detail, regarding a character of “please increase boiler to 24° C.”, the controller 180 can recognize “boiler” “24° C.”, and “increase” and analyze the contents as controlling an external device.

In an embodiment of the present disclosure, contents of the character can be analyzed by using various forms in addition to the method of analyzing contents of a character as described above. After the contents of the character is analyzed, the controller 180 can execute a function associated with the contents of the character based on the analysis result in step S1620.

When there is a function associated with the contents of the character according to the analysis result, the controller 180 can execute the function associated with the contents of the character. The function associated with the contents of the character may be a function executed by using the character or may be a function related to a control command corresponding to the character. Executing the function may refer to providing the function to the user by using components constituting the motion pen 200. Thus, “executing the function” may be understood as “performing the function” and “providing the function to the user”.

When there is a function associated with the contents of the character, the controller 180 can output notification information indicating that there is a function associated with the contents of the character. The notification information may be provided to the user in at least one of a visual, audible, and tactile manner. For example, when there is a function associated with the contents of the character, the controller 180 can recognize the presence of the function to the user through a voice of “Want to make a call?”. If there is no function associated with the contents of the character, the controller 180 may not output notification information. Meanwhile, the notification information may not be necessarily output. That is, even there is a function associated with the contents of the character, the notification information may not be output. This may be set when the motion pen 200 is released from the factory or may be set by a user.

Also, the controller 180 can execute the function associated with the contents of the character, based on a user's control command for executing the function associated with the contents of the character. That is, after the generated character is analyzed, when a user's additional control command is applied, the controller 180 can execute the function associated with the contents of the character. If the user's additional control command is not applied, the controller 180 can store the generated character in the memory unit 170 or may provide the function associated with the character to the user.

The user's control command may have various forms such as a gesture command, a touch command, a voice command, or a control command using a proximity sensor. For example, the gesture command may be generated according to a movement of the main body 210 of the motion pen 200 which is shaken horizontally by a number of times equal to or greater than a preset number of times.

In another example, the touch command may be generated through a touch applied with pressure equal to or greater than a preset value to a contact target (for example, paper) by the motion pen 200. In another example, the voice command may be generated as a voice of “make a call” is received from the outside (for example, the user) through a speaker after the motion pen 200 generates the character. In still another example, a control command using a proximity sensor may be generated as an object (for example, the user's face) adjacent to the main body 210 of the motion pen 200 is sensed.

That is, the controller 180, as well as generating a character using the motion pen 200, may provide a function related to the generated character to the user. Meanwhile, even though the same character is generated, the controller 810 may perform different functions according to a user's control command applied additionally.

For example, as illustrated in the left upper drawing of FIG. 17A, the controller 180 can generate a character according to a movement of the main body 210 of the pen motion 200 which performs handwriting on paper 1810. Here, the controller 180 can analyze the generated character and determine that the generated character is phone number information according to the analysis result.

Thereafter, as illustrated in the right upper and right lower drawings, when the user's face is sensed within a preset region of the main body 210, the controller 180 can transmit a call signal to an external device 1820 indicated by the phone number based on the detection of the face. That is, the user of the motion pen 200 may transmit a call signal to the external terminal 1820 indicated by the phone number by simply writing down a phone number on paper by using the motion pen 200.

Thus, in an embodiment of the present disclosure, those who cannot use a mobile terminal with ease may control an operation of a mobile terminal may be controlled through handwriting, without having to manipulate the mobile terminal itself. Also, after the generation of a character, when a user's control command for outputting the character to an external device is received, the controller 180 can transmit the character such that the character may be output on the external device 130.

The external device may be an external device storing identification information by the user or may be a previously designated external device. For example, the external device may be an external device able to perform near field communication with the motion pen 200, may be an external device storing identification information in the memory unit 170 of the motion pen 200, or may be an external device approved by the user before transmission of the character information. For example, as illustrated in the upper drawing of FIG. 17B, when the user performs handwriting on the paper 1810 using the motion pen 200, the controller 180 can generate character information corresponding to the handwriting performed through a movement of the motion pen 200.

Thereafter, as illustrated in the lower drawing of FIG. 17B, when it is sensed that the user taps the paper 1810 using the motion pen 200, the controller 180 can transmit the generated character information to an external device 1830. Here, the external device 1830 may be a device including a display unit able to output character information and a communication unit for performing communication with the motion pen 200. For example, the external device 1830 may be a projector including a communication unit. That is, without a mobile terminal, the user can perform handwriting on the paper 1810 in a meeting room and immediately output the same to the projector. Thus, user convenience of portability may be increased.

Also, after transmitting the character information to the projector, the controller 180 can receive a feedback signal (or a response signal) indicating that the transmission of the character information has been successfully performed. Here, when the feedback signal indicating that the character information has been received by the external device is not received, the controller 180 can continuously transmit the character information until when the response signal is received, or may output notification information indicating that the character information is not transmitted.

Also, the controller 180 can perform different functions according to results of analyzing the contents of the character generated by the motion pen 200. That is, after the character is generated, even when the same user's control command is received, the controller 180 can perform different functions according to contents of the character.

For example, as illustrated in the left drawing of FIG. 17C, the controller 180 can generate a character using a movement of the motion pen 200 which performs a handwriting input on the paper 1810. Here, the controller 180 can analyze contents of the generated character. For example, the contents of the generated character may be identification information. For example, as illustrated in the left drawing of FIG. 17C, contents of the character may include phone number information.

When the contents of the character is analyzed, the controller 180 can perform a function associated with the contents of the character. For example, as illustrated in the right drawing of FIG. 17C, the function associated with the contents of the character may be a function of transmitting a message to an external device indicated by the identification information.

Here, based on a user's control command for transmitting a message, the controller 180 can transmit the generated character to the external device indicated by the phone number. For example, as illustrated in the right drawing of FIG. 17C, in response to a tap applied to the paper 1810, the controller 180 can transmit a message “when do you come? to the external terminal indicated by the phone number.

In another example, as illustrated in the left drawing of FIG. 17D, the controller 180 can generate a character using a movement of the motion pen 200 which performs a handwriting input on the paper 1810. Here, the controller 180 can analyze contents of the generated character. For example, the contents of the generated character may be identification information. For example, as illustrated in the left drawing of FIG. 17D, the contents of the character may include e-mail address information.

When the contents of the character is analyzed, the controller 180 can execute a function associated with the contents of the character. For example, as illustrated on the right side of the FIG. 17D, the function associated with the contents of the character may be a function of sending a mail to an external server indicated by the e-mail information.

Here, based on the user's control command for sensing a mail, the controller 180 transmits the generated character to the external server indicated by the e-mail information. For example, as illustrated in the right drawing of FIG. 17D, in response to a tap applied to the paper 1810, the controller 180 can send a mail of “How's it going?” to an external terminal indicated by the phone number information.

Also, when the function associated with the generated character is executed, the controller 180 can output notification information indicating that the function associated with the generated character has been executed. For example, after sending a message or a mail to the external terminal, the controller 180 can output notification information indicating that the message or the mail has been transmitted, on the display unit or may output the notification information by voice.

Thus, the present disclosure provides a UX which resolves the user inconvenience of going through several steps to use the function of the mobile terminal and which provides a friendly touch to users who are not familiar with the use of the mobile terminal.

Also, the controller 180 can transmit a generated character to a previously designated external terminal and store the generated character in the external terminal by the motion pen 200. The previously designated external terminal is a terminal able to perform communication with the motion pen 200 and may be a mobile terminal or a tablet. The previously designated external terminal may be a terminal set by the user of the motion pen 200, which may be an external terminal storing identification information by the user of the motion pen 200 or an external terminal previously approved by the user. Here, the external terminal previously approved by the user can be an external terminal completely authenticated by the user according to authentication information, which is allowed for receiving character information.

Here, upon receiving the generated character, the previously designated external terminal may execute a function associated with the generated character. Here, the performing of the function associated with the generated character may refer to executing the function associated with the generated character and processing the generated character by using the associated function.

Here, the function associated with the generated function may be a function that can be executed in the previously designated external terminal. That is, the function associated with the generated character may be installed in the previously designated external terminal in advance. If it is determined that the function associated with the generated character has not been installed in the previously designated external terminal, the previously designated external terminal may search for a function associated with the generated character from an external server (for example, Google player, App store, and the like), and automatically install the searched function or may provide notification information such that the function associated with the generated character by a user selection.

When a control command related to the external device is generated, the controller 180 can transmit the control command to the external device according to a user request or automatically. For example, as illustrated in the first drawing of FIG. 17E, when the generated character includes schedule information (information including date, time, and location), the external device may execute a schedule management function by using the schedule information.

The schedule management function refers to an application for managing a schedule of the user, which may be a function previously installed in the external device. If the schedule management function has not been installed, the external device may search an external server for the schedule management function and may automatically install the schedule management function or may provide notification information for installing the schedule management function to the user. In more detail, as illustrated in the second drawing of FIG. 17E, when the schedule management function is executed, a mobile terminal 1000 may store the generated character information as a schedule in the memory unit 170. Also, after transmitting character information to the mobile terminal 1000, the controller 180 can receive a feedback signal (or a response signal) indicating that the character information has been successfully transmitted.

Here, when the feedback signal indicating that the character information has been received by the mobile terminal 1000 is not received, the controller 180 can continue to transmit the character information until when the response signal is received, or may output notification information indicating that the character information has not been transmitted, to the user. Also, the controller 180 can provide information related to the generated character to the user.

Information related to the generated character may be information related contents of the generated character or information indicating the generated character. In more detail, the controller 180 can detect information related to the generated character from the memory unit 170 based on at least one of a specific word, a specific command, a specific symbol, and a specific pattern included in the contents of the generated character. Meanwhile, analysis of the contents of the generated character may be set according to various references in addition to the references described above.

For example, as illustrated in FIG. 17F, when numbers (2 and 3) and an operator (x) are generated according to a movement of the motion pen 200, the controller 180 can output a result value (6) using the numbers and the operator. Here, the result value may be output visually or audibly.

Also, the controller 180 can generate a control command for an external terminal based on contents of character information generated according to a movement of the motion pen 220. Here, the external device may be an external device previously set by the user, may be an external device authenticated by the user, or may be an external device whose identification information is stored in the memory unit 170. Also, the external device is a device able to communicate with the motion pen 220, which may be a home appliance having a communication unit (for example, a smart refrigerator, a smart TV, a smart boiler, a smart air-conditioner, a smart cleaner, a smart gas range, and the like), a tablet, a navigation device, a connected car, and the like.

When the control command for the external device is generated, the controller 180 can transmit the control command to the external device according to a user request or automatically. For example, when a character of “increase boiler to 24° C.” is generated, the controller 180 can generate a control command for increasing a temperature of a boiler, and transmit the control command to the boiler such that a temperature of the boiler may be increased. That is, the user can easily transmit the control command to the external device even from an external location, rather than in a house.

Thus, in an embodiment of the present disclosure, handwriting may be performed only with the motion pen 200 without using any additional device, and a control command for an external device may be easily transmitted from an external location. Also, when an event is generated in the motion pen 200 from the outside, the controller 180 can execute a function related to the event by using a character generated through a movement of the motion pen 200. For example, when a call signal is received, the controller 180 can generate a character based on a movement of the motion pen 200, and execute a function related to the call signal by using the generated character. The function related to the call signal may be a function of answering a call, a function of making a call, a function of refusing to take a call, and the like.

For example, as illustrated in the left drawing of FIG. 17H, the motion pen 200 may receive a call signal from an external device. Here, the user can write down “yes” using the motion pen 200, and 180 the controller 180 can execute a function of answering a call to correspond to a movement of the handwriting of the user. Further, the user can write down “no” using the motion pen 200, and the controller 180 can execute the function of refusing to take the call corresponding to a movement of the handwriting of the user.

In addition, although not shown, after the call signal is received, when a control command for terminating the call signal is received, the controller 180 can terminate the call signal. Here, the control command for terminating the call signal may be a gesture command, a touch command, and the like. For example, after the call signal is received, the user can make a gesture of putting down the motion pen 200. In this state, when a preset period of time has lapsed, the control until 80 may automatically terminate the call signal or may provide notification information indicating that the call signal should be terminated, to the user. In another example, when an object is not sensed for a period of time equal to or greater than a preset period of time in a region adjacent to the main body 210 of the motion pen 200, the controller 180 can automatically terminate the call signal or may provide notification information indicating that the call signal should be terminated, to the user.

That is, by performing a function related to an event by using a character generated through handwriting, the controller 180 can provide easier user experience (UX) to those who may have difficulty in using the mobile terminal.

According to embodiments of the present disclosure, the motion pen can recognize a handwriting input applied to paper, or the like, for which a signal does not need to be transmitted to an external device, and provide the recognized handwriting input to other terminal. Thus, even without a separate terminal for recognizing the motion pen, various functions may be executed by the motion pen itself.

Also, a character generated through a movement of the pen may be transmitted to an external device and displayed in the external device. Thus, in an embodiment of the present disclosure, since a character is generated by using a movement of the pen and provided to an external device, the pan which is compatible with various devices may be provided.

In addition, the motion pen of an embodiment of the present invention has a natural and comfortable sense of handwriting. Moreover, the present disclosure provides various functions to those who have difficulty in using a mobile terminal, through handwriting, without the necessity of manipulating a mobile terminal, whereby an operation of a mobile terminal may be controlled.

Advantages of the mobile terminal and the method for controlling the same according to embodiments of the present disclosure are as follows. In an embodiment of the present disclosure, a motion pen can generate a control command through a movement of the motion pen itself and provide the generated control command to other terminal. Thus, even without a separate terminal for recognizing the motion pen, various functions can be executed by the motion pen itself.

Also, a character generated through a movement of the pen can be transmitted to an external device and displayed in the external device. Thus, in an embodiment of the present disclosure, since a character is generated by using a movement of the pen and provided to an external device, the pen which is compatible with various devices may be provided.

In addition, the motion pen according to an embodiment of the present disclosure has a natural handwriting feeling. Thus, the inconvenience of the related art touch pen in using the sense of handwriting may be reduced. Moreover, the present disclosure provides various functions to those who have difficulty in using a mobile terminal, through handwriting, without the necessity of manipulating a mobile terminal, whereby an operation of a mobile terminal may be controlled. That is, the present disclosure provides an easier UX to those who may have difficulty in using the mobile terminal.

The present disclosure described above may be implemented as a computer-readable code in a medium in which a program is recorded. The computer-readable medium includes any type of recording device in which data that can be read by a computer system is stored. The computer-readable medium may be, for example, a hard disk drive (HDD), a solid state disk (SSD), a silicon disk drive (SDD), a ROM, a RAM, a CD-ROM, a magnetic tape, a floppy disk, an optical data storage device, and the like. The computer-readable medium also includes implementations in the form of carrier waves (e.g., transmission via the Internet). Also, the computer may include the controller 180 of the terminal. Thus, the foregoing detailed description should not be interpreted limitedly in every aspect and should be considered to be illustrative. The scope of the present disclosure should be determined by reasonable interpretations of the attached claims and every modification within the equivalent range are included in the scope of the present disclosure.

The foregoing embodiments and advantages are merely and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the embodiments described herein may be combined in various ways to obtain additional and/or alternative embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A motion pen comprising:
a main body;
a first sensing unit configured to sense a rotational movement of the main body;
a second sensing unit including at least first and second sensors spaced apart from one another, and configured to sense a linear movement of the main body; and
a controller configured to:
calculate a corrected rotational movement by using a ratio of first information received from the first sensor and second information received from the second sensor, and
generate a character based on the linear movement and the corrected rotational movement.

2. The motion pen of claim 1, wherein the controller is further configured to correct a linear velocity of the rotational movement by using the ratio of the first information and the second information.

3. The motion pen of claim 1, wherein in response to a first movement of the main body being sensed through the first sensing unit and the second sensing unit, the controller is further configured to generate a first character corresponding to the first movement by using relative coordinates of the first movement.

4. The motion pen of claim 3, wherein the controller is further configured to:
set a virtual reference point for generating the first character, and
convert the relative coordinates of the first movement into absolute coordinates with respect to the reference point to generate the first character.

5. The motion pen of claim 3, wherein the controller is further configured to:
initialize the reference point whenever a preset period of time has lapsed, and
set a new reference point.

6. The motion pen of claim 5, wherein in response to the new reference point being set, the controller is further configured to convert relative coordinates of a movement of the main body into absolute coordinates based on the set new reference point to generate a character.

7. The motion pen of claim 4, further comprising:
a tip portion disposed at a first end of the motion pen configured to perform handwriting; and
a third sensing unit configured to sense pressure disposed at the other end of the motion pen,
wherein the controller is further configured to set the reference point based on pressure applied to the third sensing unit.

8. The motion pen of claim 7, wherein the controller is further configured to set the reference point to a position corresponding to a point in time at which the pressure applied to the third sensing unit is sensed.

9. The motion pen of claim 7, wherein the controller is further configured to reset the reference point each time pressure is applied to the third sensing unit not being sensed.

10. The motion pen of claim 7, wherein the controller is further configured to:
set a position corresponding to a point in time at which pressure applied to the third sensing unit starts to be sensed, as the reference point, and
convert relative coordinates corresponding to a movement of the main body into absolute coordinates based on the reference point to generate a character.

11. The motion pen of claim 7, wherein the controller is further configured to sense a movement of the main body for generating the first character, from a point in time at which pressure is sensed by the third sensing unit.

12. The motion pen of claim 11, wherein in response to pressure applied to the third sensing unit not being sensed for a preset period of time, the controller is further configured not to sense a movement of the main body any longer such that the character corresponding to the movement of the main body is not generated.

13. The motion pen of claim 1, further comprising:
a communication unit configured to perform communication with an external device,
wherein the controller is further configured to transmit character information representing the generated character to the external device through the communication unit such that the generated character is displayed on the external device.

14. The motion pen of claim 13, wherein the controller is further configured to:
generate a control command related to the generated character, and
transmit the control command to the external device such that a function indicated by the control command is executed.

15. The motion pen of claim 1, wherein the first sensor and the second sensor are spaced apart from one another at both ends of the main body such that the sensed rotational movement of the main body is corrected.

16. A method of controlling a motion pen, the method comprising:
sensing, via a first sensing unit, a rotational movement of a main body of the motion pen;
sensing, via a second sensing unit including at least first and second sensors spaced apart from one another, a linear movement of the main body;
calculating, via a controller, a corrected rotational movement by using a ratio of first information received from the first sensor and second information received from the second sensor; and
generating, via the controller, a character based on the linear movement and the corrected rotational movement.

17. The method of claim 16, further comprising:
correcting a linear velocity of the rotational movement by using the ratio of the first information and the second information.

18. The method of claim 15, wherein in response to a first movement of the main body being sensed through the first sensing unit and the second sensing unit, the method further comprises generating a first character corresponding to the first movement by using relative coordinates of the first movement.

19. The method of claim 18, further comprising:
setting a virtual reference point for generating the first character; and
converting the relative coordinates of the first movement into absolute coordinates with respect to the reference point to generate the first character.

20. The method of claim 18, further comprising:
initializing the reference point whenever a preset period of time has lapsed; and
setting a new reference point.
